(19) United States
(12) Patent Application Publication
(10) Pub. No.: US 2013/0020023 A1
(43) Pub. Date: Jan. 24, 2013

(54) METHOD FOR MANUFACTURING LIQUID CRYSTAL DISPLAY DEVICE

(71) Applicants: Daisuke Kubota, Isehara (JP); Takahiro Yamamoto, Atsugi (JP); Tetsuji Ishitani, Atsugi (JP)

(72) Inventors: Daisuke Kubota, Isehara (JP); Takahiro Yamamoto, Atsugi (JP); Tetsuji Ishitani, Atsugi (JP)

(73) Assignee: SEMICONDUCTOR ENERGY LABORATORY CO., LTD., Atsugi-shi (JP)

(21) Appl. No.: 13/552,872

(22) Filed: Jul. 19, 2012

(30) Foreign Application Priority Data
Jul. 20, 2011 (JP) 2011-158845

(51) Int. Cl. B32B 37/06

(52) U.S. Cl. 156/275.5

(57) ABSTRACT

A liquid crystal display device which includes a liquid crystal composition exhibiting a blue phase and has high reliability is provided. In a manufacturing method of a liquid crystal display device which includes a liquid crystal composition exhibiting a blue phase, the liquid crystal composition including nematic liquid crystal, a chiral agent, a polymerizable monomer, and a photopolymerization initiator which absorbs light with a peak wavelength that is different from a peak wavelength of light absorbed by the nematic liquid crystal is used. The liquid crystal composition is capable of exhibiting a blue phase and is irradiated with light absorbed by the photopolymerization initiator so that the liquid crystal composition is polymerized.

### TECHNICAL FIELD

The present invention relates to a liquid crystal element, a liquid crystal display device, and manufacturing methods thereof.

### BACKGROUND ART

In recent years, liquid crystal has been applied to a variety of devices; in particular, a liquid crystal display device (liquid crystal display) having advantages of thinness and lightness has been used for displays in a wide range of fields.

For a larger and higher-resolution display screen, shorter response time of liquid crystal has been required, and development thereof has been advanced.

As a display mode of liquid crystal capable of quick response, a display mode using liquid crystal exhibiting a blue phase is given. The mode using liquid crystal exhibiting a blue phase achieves quick response, does not require an alignment film, and provides a wide viewing angle, and thus has been developed more actively for practical use (for example, see Patent Document 1).

### REFERENCE

[Patent Document 1] PCT International Publication No. 2005-090520

### DISCLOSURE OF INVENTION

It is an object of the present invention to provide a highly reliable liquid crystal display device which includes a liquid crystal composition exhibiting a blue phase.

In a manufacturing method of a liquid crystal display device which includes a liquid crystal composition exhibiting a blue phase, a liquid crystal composition including nematic liquid crystal, a chiral agent, a polymerizable monomer, and a photopolymerization initiator which absorbs light with a peak wavelength that is different from a peak wavelength of light absorbed by the nematic liquid crystal is used. The liquid crystal composition is capable of exhibiting a blue phase and is irradiated with light so that the liquid crystal composition is polymerized. A peak wavelength of light absorbed by the photopolymerization initiator is in a wavelength range of the irradiation light.

When the liquid crystal composition is polymerized to be a high molecular compound, the liquid crystal composition is stabilized and the temperature range in which a blue phase is exhibited can be extended. Treatment in which a liquid crystal composition is irradiated with light to be a high molecular compound is referred to as polymer stabilization treatment.

If the nematic liquid crystal in the liquid crystal composition absorbs light at the time of light irradiation in the polymer stabilization treatment, polymerization of the liquid crystal composition might be prevented. Accordingly, a wavelength of the light used for the polymer stabilization treatment is preferably such that the light is absorbed by the photopolymerization initiator but not by the nematic liquid crystal.

A peak wavelength of light the nematic liquid crystal absorbs is different from a peak wavelength of light the photopolymerization initiator absorbs and the liquid crystal composition is irradiated with light in a wavelength range including the peak wavelength of the light absorbed by the photopolymerization initiator, whereby the polymer stabilization treatment is performed on the liquid crystal composition. A liquid crystal display device manufactured by the above method can have an improved voltage holding property. This is because deterioration of the nematic liquid crystal due to light irradiation can be reduced, and the photopolymerization initiator can be activated by the light irradiation, so that polymerization can proceed effectively. Thus, a highly reliable liquid crystal display device can be manufactured.

A blue phase is exhibited in a liquid crystal composition having strong twisting power and has a double twist structure. The liquid crystal composition shows a cholesteric phase, a cholesteric blue phase, an isotropic phase, or the like depending on conditions.

A cholesteric blue phase which is a blue phase shows three structures of blue phase I, blue phase II, and blue phase III from the low temperature side. A cholesteric blue phase which is a blue phase is optically isotropic, and blue phase I and blue phase II have body-centered cubic symmetry and simple cubic symmetry, respectively. In the cases of blue phase I and blue phase II, Bragg diffraction is seen in the range from ultraviolet light to visible light.

The chiral agent is used to induce twisting of the liquid crystal composition, align the liquid crystal composition in a helical structure, and make the liquid crystal composition exhibit a blue phase. For the chiral agent, a compound which has an asymmetric center, high compatibility with the liquid crystal composition, and strong twisting power is used. In addition, the chiral agent is an optically active substance; a higher optical purity is better and the most preferable optical purity is 99% or higher.

One embodiment of the invention disclosed in this specification is a method for manufacturing a liquid crystal display device, including the steps of preparing a first substrate and a second substrate between which a liquid crystal composition which is capable of exhibiting a blue phase and includes nematic liquid crystal, a chiral agent, a polymerizable monomer, and a photopolymerization initiator is provided; and irradiating the liquid crystal composition with light absorbed by the photopolymerization initiator to polymerize the liquid crystal composition. Between the first substrate and the liquid crystal composition, a first electrode layer and a second electrode layer are provided. A peak wavelength of light absorbed by the nematic liquid crystal is different from a peak wavelength of the light absorbed by the photopolymerization initiator.

Another embodiment of the invention disclosed in this specification is a method for manufacturing a liquid crystal display device, including the steps of preparing a first substrate and a second substrate between which a liquid crystal composition which is capable of exhibiting a blue phase and includes nematic liquid crystal, a chiral agent, a polymerizable monomer, and a photopolymerization initiator is provided; and irradiating the liquid crystal composition with light absorbed by the photopolymerization initiator to polymerize the liquid crystal composition. Between the first substrate and the liquid crystal composition, a first electrode layer and a second electrode layer are provided. The nematic liquid crystal includes a plurality of compounds. Each of peak wavelengths of lights absorbed by the plurality of compounds is different from a peak wavelength of the light absorbed by the photopolymerization initiator.

In the above structure, the peak wavelength of the light absorbed by the nematic liquid crystal is (or the peak wavelengths of the lights absorbed by the plurality of compounds included in the nematic liquid crystal are) preferably outside of a wavelength range of the light with which the liquid crystal composition is irradiated.

Further, in the above structure, difference between the peak wavelength of the light absorbed by the nematic liquid crystal (or each of the peak wavelengths of the lights absorbed by the plurality of compounds included in the nematic liquid crystal) and the peak wavelength of the light absorbed by the photopolymerization initiator is preferably 20 nm or more (further preferably 40 nm or more).

Furthermore, in the above structure, as the light with which the liquid crystal composition is irradiated, light having a wavelength greater than or equal to 325 nm and less than or equal to 450 nm (preferably greater than or equal to 365 nm and less than or equal to 405 nm) can be used.

According to one embodiment of the present invention, a voltage holding property of a liquid crystal display device which includes a liquid crystal composition exhibiting a blue phase can be improved and the liquid crystal display device can have high reliability.

### BRIEF DESCRIPTION OF DRAWINGS

In the accompanying drawings:

FIGS. 1A and 1B are conceptual diagrams illustrating a method for manufacturing a liquid crystal display device;

FIGS. 2A and 2B illustrate one mode of an electrode structure of a liquid crystal display device;

FIGS. 3A to 3D each illustrate one embodiment of a liquid crystal display device;

FIGS. 4A1, 4A2, and 4B illustrate liquid crystal display modules;

FIGS. 5A to 5F each illustrate an electronic device;

FIG. 6 is a graph showing normalized absorbances of liquid crystals 1 to 7 and a photopolymerization initiator and light irradiances; and

FIG. 7 is a graph showing voltage holding rates of a liquid crystal element 1 and a liquid crystal element 2.

### BEST MODE FOR CARRYING OUT THE INVENTION

Embodiments and examples of the present invention will be described in detail with reference to the accompanying drawings. Note that the present invention is not limited to the following description, and it will be easily understood by those skilled in the art that modes and details can be modified in various ways without departing from the spirit and scope of the present invention. Thus, the present invention should not be construed as being limited to the description in the following embodiments and examples. In the structures described below, the same portions or portions having similar functions are denoted by the same reference numerals in different drawings, and explanation thereof will not be repeated.

Note that the ordinal numbers such as “first”, “second”, and “third” in this specification are used for convenience and do not denote the order of steps and the stacking order of layers. In addition, the ordinal numbers in this specification do not denote particular names which specify the present invention.

### Embodiment 1

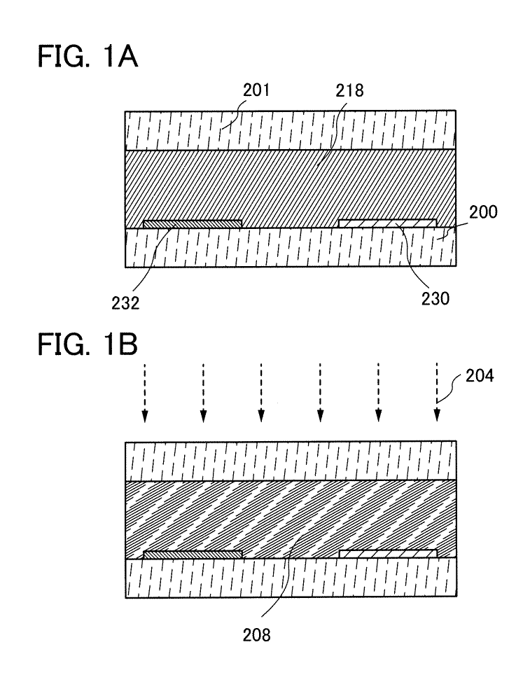

A liquid crystal display device according to one embodiment of the present invention will be described with reference to FIGS. 1A and 1B. FIGS. 1A and 1B are cross-sectional views illustrating a method for manufacturing the liquid crystal display device.

In the liquid crystal display device in FIG. 1A, a pixel electrode layer 230 and a common electrode layer 232 which are adjacent to each other are provided between a first substrate 200 and a liquid crystal composition 218 exhibiting a blue phase and including nematic liquid crystal, a chiral agent, a polymerizable monomer, and a photopolymerization initiator which absorbs light with a peak wavelength that is different from a peak wavelength of light absorbed by the nematic liquid crystal. Before light irradiation treatment of the polymerizable monomer, the entire region of the liquid crystal composition 218 is a region having a low degree of polymerization.

The nematic liquid crystal may include a plurality of compounds. In that case, the compounds included in the nematic liquid crystal and the photopolymerization initiator are selected such that each of peak wavelengths of lights absorbed by the compounds is different from a peak wavelength of light absorbed by the photopolymerization initiator.

Further, difference between the peak wavelength of the light absorbed by the nematic liquid crystal (or each of the peak wavelengths of the lights absorbed by the plurality of compounds included in the nematic liquid crystal) and the peak wavelength of the light absorbed by the photopolymerization initiator is preferably 20 nm or more (further preferably 40 nm or more).

Examples of the nematic liquid crystal include a biphenyl-based compound, a terphenyl-based compound, a phenylcyclohexyl-based compound, a biphenylcyclohexyl-based compound, a phenylbicyclohexyl-based compound, a benzoic acid phenyl-based compound, a cyclohexyl benzoic acid phenyl-based compound, a phenyl benzoic acid phenyl-based compound, a bicyclohexyl carboxylic acid phenyl-based compound, an azomethine-based compound, an azo-based compound, an azoxy-based compound, a stilbene-based compound, a bicyclohexyl-based compound, a phenylpyrimidine-based compound, a biphenylpyrimidine-based compound, a pyrimidine-based compound, and a biphenyl ethyne-based compound.

As the polymerizable monomer, a photopolymerizable (photocurable) monomer which can be polymerized by light, a polymerizable monomer which can be polymerized by heat and light, or the like can be used.

The polymerizable monomer may be a monofunctional monomer such as acrylate or methacrylate; a polyfunctional monomer such as diacrylate, triacrylate, dimethacrylate, or trimethacrylate; or a mixture thereof. Further, the polymerizable monomer may have liquid crystallinity, non-liquid crystallinity, or both of them. As the photopolymerizable monomer, typically, a UV polymerizable monomer can be used.

As the photopolymerization initiator, a radical polymerization initiator which generates radicals by light irradiation can be used.

The liquid crystal composition 218 can be formed by a dispensing method (dropping method), or an injection method in which the liquid crystal composition 218 is injected using capillary action or the like after the first substrate 200 and a second substrate 201 are attached to each other.

Next, the liquid crystal composition 218 is irradiated with a light 204 which is absorbed by the photopolymerization initiator as polymer stabilization treatment, so that the polymerizable monomer polymerizes and thus a liquid crystal composition 208 is formed (see FIG. 1B). The polymer stabilization treatment can extend the temperature range where a blue phase is exhibited in the liquid crystal display device.

Further, sufficient polymer stabilization treatment can improve impact resistance of the liquid crystal display device including the liquid crystal composition exhibiting a blue phase.

The peak wavelength of the light absorbed by the nematic liquid crystal is (or the peak wavelengths of the lights absorbed by the plurality of compounds included in the nematic liquid crystal are) preferably outside of a wavelength range of the light 204 with which the liquid crystal composition 218 is irradiated.

As the light 204 with which the liquid crystal composition 218 is irradiated, light having a wavelength greater than or equal to 325 nm and less than or equal to 450 nm (preferably greater than or equal to 365 nm and less than or equal to 405 nm) can be used.

If the nematic liquid crystal (or the plurality of compounds included in the nematic liquid crystal) in the liquid crystal composition 218 absorbs the light 204 at the time of light irradiation in the polymer stabilization treatment, polymerization of the liquid crystal composition 218 might be prevented. Accordingly, a wavelength of the light 204 used for the polymer stabilization treatment is preferably such that the light is absorbed by the photopolymerization initiator but not by the nematic liquid crystal (or the plurality of compounds included in the nematic liquid crystal).

A peak wavelength of light the nematic liquid crystal absorbs is different from a peak wavelength of light the photopolymerization initiator absorbs and the liquid crystal composition is irradiated with light absorbed by the photopolymerization initiator, whereby the polymer stabilization treatment is performed on the liquid crystal composition. When a liquid crystal display device is manufactured as described above, a voltage holding property of the liquid crystal display device can be improved. Further, response speed can be increased. This is because deterioration of the nematic liquid crystal due to light irradiation can be reduced, and the photopolymerization initiator can be activated by the light irradiation, so that polymerization can proceed effectively. Thus, a highly reliable liquid crystal display device can be manufactured.

The polymer stabilization treatment may be performed on a liquid crystal composition exhibiting an isotropic phase or a liquid crystal composition exhibiting a blue phase under the control of the temperature. A temperature at which the phase changes from a blue phase to an isotropic phase when the temperature rises, or a temperature at which the phase changes from an isotropic phase to a blue phase when the temperature falls is referred to as the phase transition temperature between a blue phase and an isotropic phase. For example, the polymer stabilization treatment can be performed in the following manner: after a liquid crystal composition to which a photopolymerizable monomer is added is heated to exhibit an isotropic phase, the temperature of the liquid crystal composition is gradually lowered so that the phase changes to a blue phase, and then, light irradiation is performed while the temperature at which a blue phase is exhibited is kept.

With the structure in FIGS. 1A and 1B, a method in which the gray scale is controlled by generating an electric field substantially parallel (i.e., in the lateral direction) to a substrate to move liquid crystal molecules in a plane parallel to the substrate can be used. With an electric field generated between the pixel electrode layer 230 and the common electrode layer 232, liquid crystal is controlled. An electric field in the lateral direction is applied to the liquid crystal, so that liquid crystal molecules can be controlled by the electric field. The liquid crystal composition exhibiting a blue phase is capable of quick response. Thus, a high-performance liquid crystal element and a high-performance liquid crystal display device can be achieved.

For example, such a liquid crystal composition exhibiting a blue phase, which is capable of quick response, can be favorably used for a successive additive color mixing method (field sequential method) in which light-emitting diodes (LEDs) of RGB or the like are arranged in a backlight unit and color display is performed by time division, or a three-dimensional display method using a shutter glasses system in which images for the right eye and images for the left eye are alternately viewed by time division.

Further, a blue phase is optically isotropic and thus has no viewing angle dependence. Consequently, an alignment film is not necessarily formed; thus, display image quality can be improved and cost can be reduced.

The distance between the pixel electrode layer 230 and the common electrode layer 232, which are adjacent to each other with the liquid crystal composition 208 interposed therebetween, is a distance at which liquid crystal in the liquid crystal composition 208 between the pixel electrode layer 230 and the common electrode layer 232 responds to a predetermined voltage applied to each of the pixel electrode layer 230 and the common electrode layer 232. Alternatively, the voltage applied is controlled depending on the distance as appropriate.

The maximum thickness (film thickness) of the liquid crystal composition 208 is preferably greater than or equal to 1 μm and less than or equal to 20 μm.

Although not illustrated in FIGS. 1A and 1B, an optical film such as a polarizing plate, a retardation plate, or an anti-reflection film, or the like is provided as appropriate. For example, circular polarization with a polarizing plate and a retardation plate may be used. In addition, a backlight or the like can be used as a light source.

In this specification, a substrate provided with a semiconductor element (e.g., a transistor) or a common electrode layer is referred to as an element substrate (first substrate), and a substrate which faces the element substrate with a liquid crystal composition provided therebetween is referred to as a counter substrate (second substrate).

As the liquid crystal display device according to one embodiment of the present invention, a transmissive liquid crystal display device in which display is performed by transmission of light from a light source, a reflective liquid crystal display device in which display is performed by reflection of incident light, or a transflective liquid crystal display device in which a transmissive type and a reflective type are combined can be provided.

In the case of the transmissive liquid crystal display device, a pixel electrode layer, a common electrode layer, a first substrate, a second substrate, and other components such as an insulating film and a conductive film, which are provided in a pixel region through which light is transmitted, preferably have a property of transmitting light in the visible wavelength range; however, if an opening pattern is provided, a non-transmitting material such as a metal film may be used depending on the shape.

On the other hand, in the case of the reflective liquid crystal display device, a reflective component which reflects light transmitted through the liquid crystal composition (e.g., a reflective film or substrate) may be provided on the side opposite to the viewing side of the liquid crystal composition. Thus, a substrate, an insulating film, and a conductive film which are provided between the viewing side and the reflective component and through which light is transmitted have a light-transmitting property with respect to light in the visible wavelength range. Note that in this specification, a light-transmitting property refers to a property of transmitting at least light in the visible wavelength range.

The pixel electrode layer 230 and the common electrode layer 232 may be formed with the use of one or more of the following: an indium tin oxide, a conductive material in which zinc oxide is mixed into indium oxide, a conductive material in which silicon oxide (SiO₂) is mixed into indium oxide, an indium oxide containing organoindium, organotin, and tungsten oxide, an indium zinc oxide containing tungsten oxide, an indium oxide containing titanium oxide, and an indium tin oxide containing titanium oxide; graphene; metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and metal nitrides thereof.

As the first substrate 200 and the second substrate 201, a glass substrate of barium borosilicate glass, aluminoborosilicate glass, or the like; a quartz substrate; a plastic substrate; or the like can be used. Note that in the case of the reflective liquid crystal display device, a metal substrate such as an aluminum substrate or a stainless steel substrate may be used as a substrate on the side opposite to the viewing side.

As described above, a voltage holding property of the liquid crystal display device exhibiting a blue phase can be improved and the liquid crystal display device can have high reliability.

This embodiment can be implemented in appropriate combination with any of the structures described in the other embodiments.

### Embodiment 2

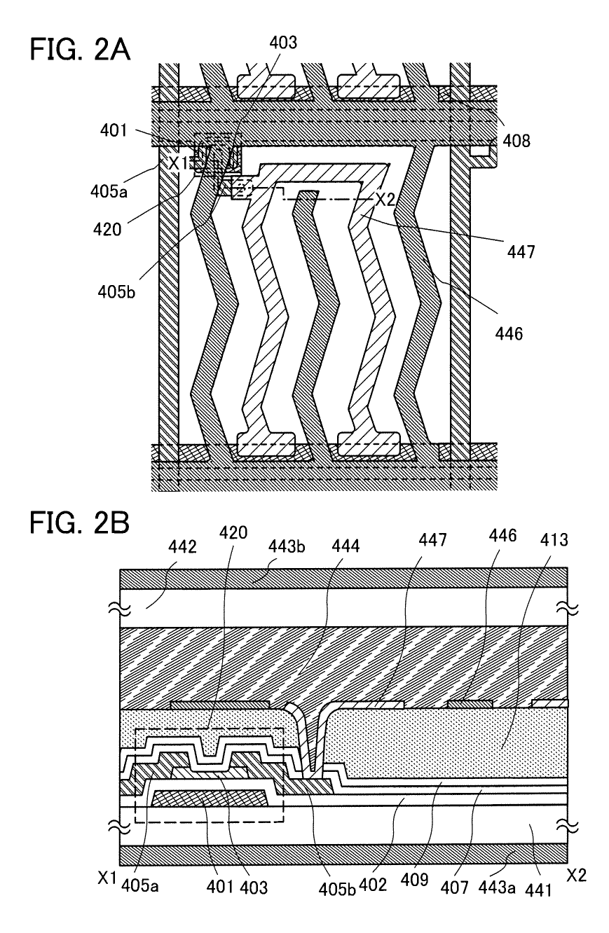

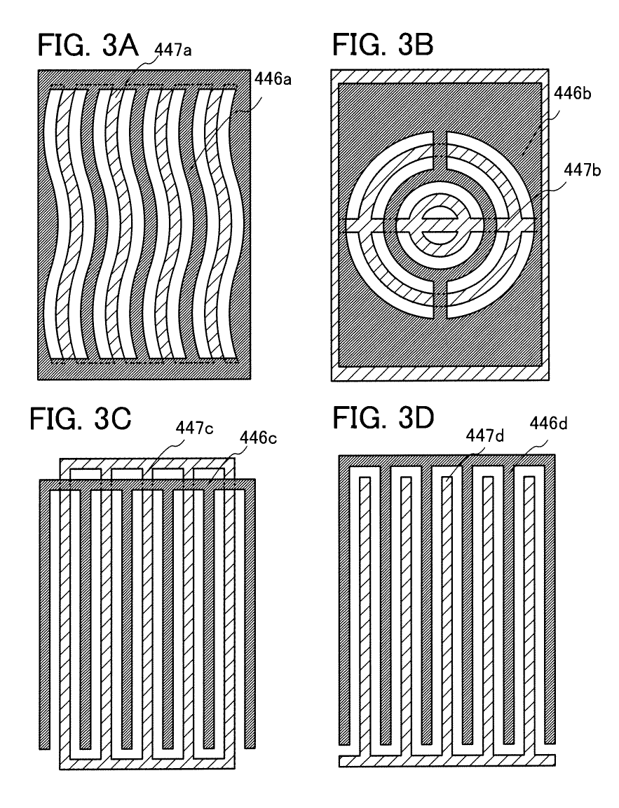

As a liquid crystal display device according to one embodiment of the present invention, a passive matrix liquid crystal display device and an active matrix liquid crystal display device can be provided. In this embodiment, examples of active matrix liquid crystal display devices according to one embodiment of the present invention will be described with reference to FIGS. 2A and 2B and FIGS. 3A to 3D.

FIG. 2A is a plan view of a liquid crystal display device and illustrates one pixel. FIG. 2B is a cross-sectional view taken along line X1-X2 in FIG. 2A.

In FIG. 2A, a plurality of source wiring layers (including a wiring layer 405a) is arranged so as to be parallel to (extended in the longitudinal direction in the drawing) and apart from each other. A plurality of gate wiring layers (including a gate electrode layer 401) is arranged so as to be extended in the direction substantially perpendicular to the source wiring layers (in the horizontal direction in the drawing) and apart from each other. Common wiring layers 408 are provided so as to be adjacent to the respective gate wiring layers and extended in the direction substantially parallel to the gate wiring layers, that is, in the direction substantially perpendicular to the source wiring layers (in the horizontal direction in the drawing). A roughly rectangular space is surrounded by the source wiring layers, the common wiring layer 408, and the gate wiring layer. In this space, a pixel electrode layer and a common electrode layer of the liquid crystal display device are provided. A transistor 420 for driving the pixel is provided at the upper left corner of the drawing. A plurality of pixel electrode layers and a plurality of transistors are arranged in a matrix.

In the liquid crystal display device in FIGS. 2A and 2B, a first electrode layer 447 electrically connected to the transistor 420 serves as a pixel electrode layer, and a second electrode layer 446 electrically connected to the common wiring layer 408 serves as a common electrode layer. Note that a capacitor is formed by the first electrode layer and the common wiring layer. Although the common electrode layer can operate in a floating state (electrically isolated state), the potential of the common electrode layer may be set to a fixed potential, preferably to a potential around an intermediate potential of an image signal which is transmitted as data at such a level as not to generate flickers.

A method can be used in which the gray scale is controlled by generating an electric field substantially parallel (i.e., in the lateral direction) to a substrate to move liquid crystal molecules in a plane parallel to the substrate. For such a method, an electrode structure used in an IPS mode illustrated in FIGS. 2A and 2B and FIGS. 3A to 3D can be employed.

In a lateral electric field mode such as an IPS mode, a first electrode layer (e.g., a pixel electrode layer with which a voltage is controlled in each pixel) and a second electrode layer (e.g., a common electrode layer with which a common voltage is applied to all pixels), each of which has an opening pattern, are located below a liquid crystal composition. Accordingly, the first electrode layer 447 and the second electrode layer 446, one of which is a pixel electrode layer and the other of which is a common electrode layer, are formed over a first substrate 441, and at least one of the first electrode layer and the second electrode layer is formed over an insulating film. The first electrode layer 447 and the second electrode layer 446 have not a flat shape but a variety of opening patterns including a bent portion or a branched comb-like portion. In the case where the first electrode layer 447 and the second electrode layer 446 have the same shape, an arrangement where one of them completely covers the other is prevented to generate an electric field between the electrodes.

The first electrode layer 447 and the second electrode layer 446 may have an electrode structure used in an FFS mode. In a lateral electric field mode such as an FFS mode, a first electrode layer (e.g., a pixel electrode layer with which a voltage is controlled in each pixel) having an opening pattern is located below a liquid crystal composition, and further, a second electrode layer (e.g., a common electrode layer with which a common voltage is applied to all pixels) having a flat shape is located below the opening pattern. In that case, the first electrode layer and the second electrode layer, one of which is a pixel electrode layer and the other of which is a common electrode layer, are formed over the first substrate 441, and the pixel electrode layer and the common electrode layer are stacked with an insulating film (or an interlayer insulating film) provided therebetween. One of the pixel electrode layer and the common electrode layer is formed below the insulating film (or the interlayer insulating film) and has a flat shape, whereas the other is formed above the insulating film (or the interlayer insulating film) and has a variety of opening patterns including a bent portion or a branched comb-like portion. In the case where the first electrode layer 447 and the second electrode layer 446 have the same shape, an arrangement where one of them completely covers the other is prevented to generate an electric field between the electrodes.

In this embodiment, a liquid crystal composition exhibiting a blue phase and including nematic liquid crystal, a chiral agent, a polymerizable monomer, and a photopolymerization initiator which absorbs light with a peak wavelength that is different from a peak wavelength of light absorbed by the nematic liquid crystal is used as a liquid crystal composition 444. The liquid crystal composition 444 is provided in a liquid crystal display device with a blue phase exhibited (with a blue phase shown) by polymer stabilization treatment. The liquid crystal composition 444 further includes an organic resin.

A peak wavelength of light the nematic liquid crystal absorbs is different from a peak wavelength of light the photopolymerization initiator absorbs and the liquid crystal composition is irradiated with light absorbed by the photopolymerization initiator, whereby the polymer stabilization treatment is performed on the liquid crystal composition. With the above manufacturing method, a voltage holding property of the liquid crystal display device can be improved. Further, response speed can be increased. This is because deterioration of the nematic liquid crystal due to light irradiation can be reduced, and the photopolymerization initiator can be activated by the light irradiation, so that polymerization can proceed effectively. Thus, a highly reliable liquid crystal display device can be manufactured.

With an electric field generated between the first electrode layer 447 as the pixel electrode layer and the second electrode layer 446 as the common electrode layer, liquid crystal in the liquid crystal composition 444 is controlled. An electric field in the lateral direction is formed in the liquid crystal, so that liquid crystal molecules can be controlled using the electric field. Since the liquid crystal molecules aligned to exhibit a blue phase can be controlled in the direction parallel to the substrate, a wide viewing angle is obtained.

FIGS. 3A to 3D illustrate other examples of the first electrode layer 447 and the second electrode layer 446. As illustrated in top views of FIGS. 3A to 3D, first electrode layers 447a to 447d and second electrode layers 446a to 446d are arranged alternately. In FIG. 3A, the first electrode layer 447a and the second electrode layer 446a have wavelike shapes with curves. In FIG. 3B, the first electrode layer 447b and the second electrode layer 446b have shapes with concentric circular openings. In FIG. 3C, the first electrode layer 447c and the second electrode layer 446c have comb-like shapes and partly overlap with each other. In FIG. 3D, the first electrode layer 447d and the second electrode layer 446d have comb-like shapes in which the electrode layers are engaged with each other. In the case where the first electrode layers 447a, 447b, and 447c overlap with the second electrode layers 446a, 446b, and 446c, respectively, as illustrated in FIGS. 3A to 3C, an insulating film is formed between the first electrode layer 447 and the second electrode layer 446 so that the first electrode layer 447 and the second electrode layer 446 are formed over different films.

Since the first electrode layer 447 and the second electrode layer 446 have opening patterns, they are illustrated as divided plural electrode layers in the cross-sectional view in FIG. 2B. The same applies to the other drawings of this specification.

The transistor 420 is an inverted staggered thin film transistor in which the gate electrode layer 401, a gate insulating layer 402, a semiconductor layer 403, and wiring layers 405a and 405b which function as a source electrode layer and a drain electrode layer are formed over the first substrate 441 having an insulating surface.

There is no particular limitation on the structure of a transistor which can be used for the liquid crystal display device disclosed in this specification. For example, a staggered type or a planar type having a top-gate structure or a bottom-gate structure can be employed. The transistor may have a single-gate structure in which one channel formation region is formed, a double-gate structure in which two channel formation regions are formed, or a triple-gate structure in which three channel formation regions are formed. Alternatively, the transistor may have a dual-gate structure including two gate electrode layers positioned over and below a channel formation region with a gate insulating layer provided therebetween.

An insulating film 407 which is in contact with the semiconductor layer 403, and an insulating film 409 are provided so as to cover the transistor 420. An interlayer film 413 is stacked over the insulating film 409.

There is no particular limitation on the method for forming the interlayer film 413, and the following method can be employed depending on the material: a spin coating method, a dip coating method, a spray coating method, a droplet discharging method (such as an ink-jet method), a printing method (such as a screen printing method or an offset printing method), a roll coating method, a curtain coating method, a knife coating method, or the like.

The first substrate 441 and a second substrate 442 which is a counter substrate are firmly attached to each other with a sealant with the liquid crystal composition 444 provided therebetween. The liquid crystal composition 444 can be formed by a dispensing method (dropping method), or an injection method in which liquid crystal is injected using capillary action or the like after the first substrate 441 and the second substrate 442 are attached to each other.

As the sealant, typically, a visible light curable resin, a UV curable resin, or a thermosetting resin is preferably used. Typically, an acrylic resin, an epoxy resin, an amine resin, or the like can be used. Further, a photopolymerization initiator (typically, a UV polymerization initiator), a thermosetting agent, a filler, or a coupling agent may be contained in the sealant.

In the case where a photocurable resin such as a UV curable resin is used as a sealant and a liquid crystal composition is formed by a dropping method, for example, the sealant may be cured in the light irradiation step of the polymer stabilization treatment.

In this embodiment, a polarizing plate 443a is provided on the outer side (on the side opposite to the liquid crystal composition 444) of the first substrate 441, and a polarizing plate 443b is provided on the outer side (on the side opposite to the liquid crystal composition 444) of the second substrate 442. In addition to the polarizing plate, an optical film such as a retardation plate or an anti-reflection film may be provided. For example, circular polarization with the polarizing plate and the retardation plate may be used. Through the above process, a liquid crystal display device can be completed.

In the case of manufacturing a plurality of liquid crystal display devices using a large-sized substrate (what is called a multiple panel method), a division step can be performed before performing the polymer stabilization treatment or before providing the polarizing plates. In consideration of the influence of the division step on the liquid crystal composition (such as alignment disorder due to force applied in the division step), it is preferable that the division step be performed after attaching the first substrate and the second substrate to each other before performing the polymer stabilization treatment.

Although not illustrated, a backlight, a sidelight, or the like may be used as a light source. Light from the light source is emitted from the side where the first substrate 441, which is an element substrate, is provided so as to pass through the second substrate 442 on the viewing side.

The first electrode layer 447 and the second electrode layer 446 can be formed using a light-transmitting conductive material such as an indium oxide containing tungsten oxide, an indium zinc oxide containing tungsten oxide, an indium oxide containing titanium oxide, an indium tin oxide containing titanium oxide, an indium tin oxide, an indium zinc oxide, an indium tin oxide to which silicon oxide is added, or graphene.

The first electrode layer 447 and the second electrode layer 446 can be formed of one or more materials selected from metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof and metal nitrides thereof.

The first electrode layer 447 and the second electrode layer 446 can be formed using a conductive composition including a conductive high molecule (also referred to as a conductive polymer).

As the conductive high molecule, what is called a π-electron conjugated conductive high molecule can be used. Examples thereof include polyaniline or a derivative thereof, polypyrrole or a derivative thereof, polythiophene or a derivative thereof, a copolymer of two or more kinds of aniline, pyrrole, and thiophene or a derivative thereof.

An insulating film serving as a base film may be provided between the first substrate 441 and the gate electrode layer 401. The base film has a function of preventing diffusion of impurity elements from the first substrate 441, and can be formed to have a single-layer structure or a stacked-layer structure using one or more of a silicon nitride film, a silicon oxide film, a silicon nitride oxide film, and a silicon oxynitride film. The gate electrode layer 401 can be formed to have a single-layer structure or a stacked-layer structure using any of metal materials such as molybdenum, titanium, chromium, tantalum, tungsten, aluminum, copper, neodymium, and scandium, and an alloy material which contains any of these materials as its main component. Alternatively, a semiconductor film typified by a polycrystalline silicon film doped with an impurity element such as phosphorus, or a silicide film such as a nickel silicide film may be used as the gate electrode layer 401. When a light-blocking conductive film is used as the gate electrode layer 401, light from a backlight (light emitted through the first substrate 441) can be prevented from entering the semiconductor layer 403.

For example, as a two-layer structure of the gate electrode layer 401, the following structures are preferable: a two-layer structure of an aluminum layer and a molybdenum layer stacked thereover, a two-layer structure of a copper layer and a molybdenum layer stacked thereover, a two-layer structure of a copper layer and a titanium nitride layer or a tantalum nitride layer stacked thereover, and a two-layer structure of a titanium nitride layer and a molybdenum layer. As a three-layer structure, a stacked-layer structure in which a tungsten layer or a tungsten nitride layer, an alloy layer of aluminum and silicon or an alloy layer of aluminum and titanium, and a titanium nitride layer or a titanium layer are stacked is preferable.

The gate insulating layer 402 can be formed, for example, by a plasma CVD method or a sputtering method, with the use of a silicon oxide film, a gallium oxide film, an aluminum oxide film, a silicon nitride film, a silicon oxynitride film, an aluminum oxynitride film, or a silicon nitride oxide film. Alternatively, a high-k material such as hafnium oxide, yttrium oxide, lanthanum oxide, hafnium silicate (HfSiₓO_{y} (x>0, y>0)), hafnium aluminate (HfAlₓO_{y} (x>0, y>0)), hafnium silicate to which nitrogen is added, or hafnium aluminate to which nitrogen is added may be used as a material for the gate insulating layer 402. The use of such a high-k material enables a reduction in gate leakage current.

Alternatively, the gate insulating layer 402 can be formed using a silicon oxide layer by a CVD method using an organosilane gas. As an organosilane gas, a silicon-containing compound such as tetraethoxysilane (TEOS) (chemical formula: Si(OC₂H₅)₄), tetramethy lsi lane (TMS) (chemical formula: Si(CH₃)₄), tetramethylcyclotetrasiloxane (TMCTS), octamethylcyclotetrasiloxane (OMCTS), hexamethyldisilazane (HMDS), triethoxysilane (SiH(OC₂H₅)₃), or trisdimethylaminosilane (SiH(N(CH₃)₂)₃) can be used. Note that the gate insulating layer 402 may have a single layer structure or a stacked-layer structure.

A material of the semiconductor layer 403 is not particularly limited and may be determined as appropriate depending on characteristics needed for the transistor 420. Examples of a material which can be used for the semiconductor layer 403 will be described.

The semiconductor layer 403 can be formed using the following material: an amorphous semiconductor formed by a chemical vapor deposition method using a semiconductor source gas typified by silane or germane or by a physical vapor deposition method such as a sputtering method; a polycrystalline semiconductor formed by crystallizing the amorphous semiconductor with the use of light energy or thermal energy; a microcrystalline semiconductor; or the like. The semiconductor layer can be formed by a sputtering method, an LPCVD method, a plasma CVD method, or the like.

A typical example of an amorphous semiconductor is hydrogenated amorphous silicon, and a typical example of a crystalline semiconductor is polysilicon. Examples of polysilicon (polycrystalline silicon) are as follows: high-temperature polysilicon that contains polysilicon formed at a process temperature of 800° C. or higher as its main component, low-temperature polysilicon that contains polysilicon formed at a process temperature of 600° C. or lower as its main component, and polysilicon obtained by crystallizing amorphous silicon with the use of an element that promotes crystallization, or the like. It is needless to say that a microcrystalline semiconductor or a semiconductor partly containing a crystal phase can be used as described above.

An oxide semiconductor may also be used. The oxide semiconductor preferably contains at least indium (In) or zinc (Zn). In particular, In and Zn are preferably contained. In addition, as a stabilizer for reducing the variation in electrical characteristics of a transistor using the oxide, the oxide semiconductor preferably contains gallium (Ga) in addition to In and Zn. Tin (Sn) is preferably contained as a stabilizer. Hafnium (Hf) is preferably contained as a stabilizer. Aluminum (Al) is preferably contained as a stabilizer. Zirconium (Zr) is preferably contained as a stabilizer.

As another stabilizer, one or plural kinds of lanthanoid selected from lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu) may be contained.

As the oxide semiconductor, for example, any of the following can be used: indium oxide; tin oxide; zinc oxide; a two-component metal oxide such as an In—Zn-based oxide, a Sn—Zn-based oxide, an Al—Zn-based oxide, a Zn—Mg-based oxide, a Sn—Mg-based oxide, an In—Mg-based oxide, or an In—Ga-based oxide; a three-component metal oxide such as an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, or an In—Lu—Zn-based oxide; and a four-component metal oxide such as an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide.

For example, the In—Ga—Zn-based oxide means an oxide containing In, Ga, and Zn as its main components and there is no limitation on the ratio of In:Ga:Zn. The In—Ga—Zn-based oxide may further include a metal element other than In, Ga, and Zn.

Alternatively, a material represented by InMO₃(ZnO)ₘ (m>0, m is not an integer) may be used as the oxide semiconductor. Here, M represents one or more metal elements selected from Ga, Fe, Mn, and Co. Further alternatively, as the oxide semiconductor, a material represented by In₂SnO₅(ZnO)ₙ (n>0, n is an integer) may be used.

For example, an In—Ga—Zn-based oxide with an atomic ratio of In:Ga:Zn=1:1:1 (=⅓:⅓:⅓), 2:2:1 (=⅖:⅖:⅕), or 3:1:2 (=½:⅙:⅓), or any of oxides whose composition is in the neighborhood of the above compositions can be used. Alternatively, an In—Sn—Zn-based oxide with an atomic ratio of In:Sn:Zn=1:1:1 (=⅓: ⅓:⅓), 2:1:3 (=⅓:⅙:½), or 2:1:5 (=¼:⅛:⅝), or any of oxides whose composition is in the neighborhood of the above compositions can be used.

However, without limitation to the materials given above, any material with an appropriate composition may be used depending on needed semiconductor characteristics (e.g., mobility, threshold voltage, and variation). To obtain needed semiconductor characteristics, it is preferable that the carrier density, the impurity concentration, the defect density, the atomic ratio between a metal element and oxygen, the interatomic distance, the density, and the like be set to appropriate values.

For example, in the case where the composition of an oxide containing In, Ga, and Zn at the atomic ratio, In:Ga:Zn=a:b:c (a+b+c=1), is in the neighborhood of the composition of an oxide containing In, Ga, and Zn at the atomic ratio, In:Ga:Zn=A:B:C (A+B+C=1), a, b, and c satisfy the following relation: (a−A)²+(b−B)²+(c−C)²≦r², and r may be 0.05, for example. The same applies to other oxides.

The oxide semiconductor may be either single crystal or non-single-crystal. In the latter case, the oxide semiconductor may be either amorphous or polycrystal. Further, the oxide semiconductor may have either an amorphous structure including a portion having crystallinity or a non-amorphous structure.

For example, an oxide semiconductor layer including a crystal having a c-axis which is substantially perpendicular to a surface of the oxide semiconductor layer can be used as a crystalline oxide semiconductor layer.

The oxide semiconductor layer including a crystal having a c-axis which is substantially perpendicular to the surface of the oxide semiconductor layer is neither single crystal nor amorphous, and is a layer of an oxide semiconductor including a crystal with c-axis alignment (also referred to as a c-axis aligned crystalline oxide semiconductor (CAAC-OS)).

CAAC-OS is an oxide semiconductor containing a crystal with c-axis alignment which has a triangular or hexagonal atomic arrangement when seen from the direction of the a-b plane, the surface, or the interface and in which metal atoms are arranged in a layered manner, or metal atoms and oxygen atoms are arranged in a layered manner along the c-axis, and the direction of the a-axis or the b-axis is varied in the a-b plane (or the surface or the interface), that is, which rotates around the c-axis. A CAAC-OS film (layer) is a thin film including crystals crystallized along the c-axis but alignment along the a-b plane does not necessarily appear.

In a broad sense, CAAC-OS is a non-single-crystal and includes a phase which has a triangular, hexagonal, regular triangular, or regular hexagonal atomic arrangement when seen from the direction perpendicular to the a-b plane and in which metal atoms are arranged in a layered manner, or metal atoms and oxygen atoms are arranged in a layered manner when seen from the direction perpendicular to the c-axis direction.

The CAAC-OS film is not a single crystal film, but this does not mean that the CAAC-OS film is composed of only an amorphous component. Although the CAAC-OS film includes a crystallized portion (crystalline portion), a boundary between one crystalline portion and another crystalline portion is not clear in some cases.

Nitrogen may be substituted for part of oxygen that is a constituent element of the CAAC-OS. The c-axes of individual crystalline portions included in the CAAC-OS film may be aligned in one direction (e.g., a direction perpendicular to a surface of a substrate over which the CAAC-OS is formed or the top surface, a film surface, or an interface of the CAAC-OS). Further or alternatively, the normals of the a-b planes of the individual crystalline portions included in the CAAC-OS film may be aligned in one direction (e.g., the direction perpendicular to the surface of the substrate, the top surface, or the interface of the CAAC-OS).

In a process of forming the semiconductor layer and the wiring layer, an etching step is used to process thin films into desired shapes. Dry etching or wet etching can be employed for the etching step.

The etching conditions (such as an etchant, etching time, and temperature) are appropriately adjusted depending on the material so that the material can be etched to have a desired shape.

As a material of the wiring layers 405a and 405b serving as source and drain electrode layers, an element selected from Al, Cr, Ta, Ti, Mo, and W; an alloy containing any of the above elements as its component; an alloy film containing a combination of any of these elements; and the like can be given. Further, in the case where heat treatment is performed, the conductive film preferably has heat resistance against the heat treatment. Since the use of aluminum alone brings disadvantages such as low heat resistance and a tendency to corrosion, aluminum is used in combination with a conductive material having heat resistance. As the conductive material having heat resistance, which is combined with aluminum, it is possible to use an element selected from titanium (Ti), tantalum (Ta), tungsten (W), molybdenum (Mo), chromium (Cr), neodymium (Nd), and scandium (Sc); an alloy containing any of these elements as its component; an alloy film containing a combination of any of these elements; or a nitride containing any of these elements as its component.

The gate insulating layer 402, the semiconductor layer 403, and the wiring layers 405a and 405b serving as source and drain electrode layers may be successively formed without being exposed to the air. Successive film formation without exposure to the air makes it possible to obtain each interface between stacked layers, which is not contaminated by atmospheric components or impurity elements in the air. Thus, variation in characteristics of the transistor can be reduced.

Note that the semiconductor layer 403 is partly etched so as to have a groove (a depressed portion).

As the insulating film 407 and the insulating film 409 which cover the transistor 420, an inorganic insulating film or an organic insulating film formed by a dry method or a wet method can be used. For example, it is possible to use a silicon nitride film, a silicon oxide film, a silicon oxynitride film, an aluminum oxide film, or a tantalum oxide film, which is formed by a CVD method, a sputtering method, or the like. Alternatively, an organic material such as polyimide, acrylic, a benzocyclobutene-based resin, polyamide, or epoxy can be used. As an alternative to such organic materials, it is possible to use a low-dielectric constant material (low-k material), a siloxane-based resin, phosphosilicate glass (PSG), borophosphosilicate glass (BPSG), or the like. A gallium oxide film can also be used as the insulating film 407.

Note that the siloxane-based resin corresponds to a resin including a Si—O—Si bond formed using a siloxane-based material as a starting material. The siloxane-based resin may include an organic group (e.g., an alkyl group or an aryl group) or a fluoro group as a substituent. The organic group may include a fluoro group. A siloxane-based resin is applied by a coating method and baked; thus, the insulating film 407 can be formed.

Alternatively, the insulating film 407 and the insulating film 409 may be formed by stacking a plurality of insulating films formed using any of these materials. For example, a structure may be employed in which an organic resin film is stacked over an inorganic insulating film.

Further, with the use of a resist mask having regions with plural thicknesses (typically, two different thicknesses) which is formed using a multi-tone mask, the number of steps in a photolithography process can be reduced, resulting in a simplified process and lower cost.

As described above, a voltage holding property of the liquid crystal display device exhibiting a blue phase can be improved and the liquid crystal display device can have high reliability.

This embodiment can be implemented in appropriate combination with any of the structures described in the other embodiments.

### Embodiment 3

A liquid crystal display device having a display function can be manufactured by manufacturing transistors and using the transistors for a pixel portion and further for a driver circuit. Further, part or the whole of the driver circuit can be formed over the same substrate as the pixel portion, using the transistor, whereby a system-on-panel can be obtained.

The liquid crystal display device includes a liquid crystal element (also referred to as a liquid crystal display element) as a display element.

Further, a liquid crystal display device includes a panel in which a liquid crystal display element is sealed, and a module in which an IC or the like including a controller is mounted to the panel. One embodiment of the present invention also relates to an element substrate, which corresponds to one mode in which the display element has not been completed in a manufacturing process of the liquid crystal display device, and the element substrate is provided with a means for supplying current to the display element in each of a plurality of pixels. Specifically, the element substrate may be in a state where it is provided only with a pixel electrode of the display element, in a state where a conductive film to be a pixel electrode has been formed and the conductive film has not yet been etched to form the pixel electrode, or in any other state.

Note that a liquid crystal display device in this specification means an image display device, a display device, or a light source (including a lighting device). Further, the liquid crystal display device includes any of the following modules in its category: a module to which a connector such as a flexible printed circuit (FPC), tape automated bonding (TAB) tape, or a tape carrier package (TCP) is attached; a module having TAB tape or a TCP which is provided with a printed wiring board at the end thereof; and a module having an integrated circuit (IC) directly mounted on a display element by a chip on glass (COG) method.

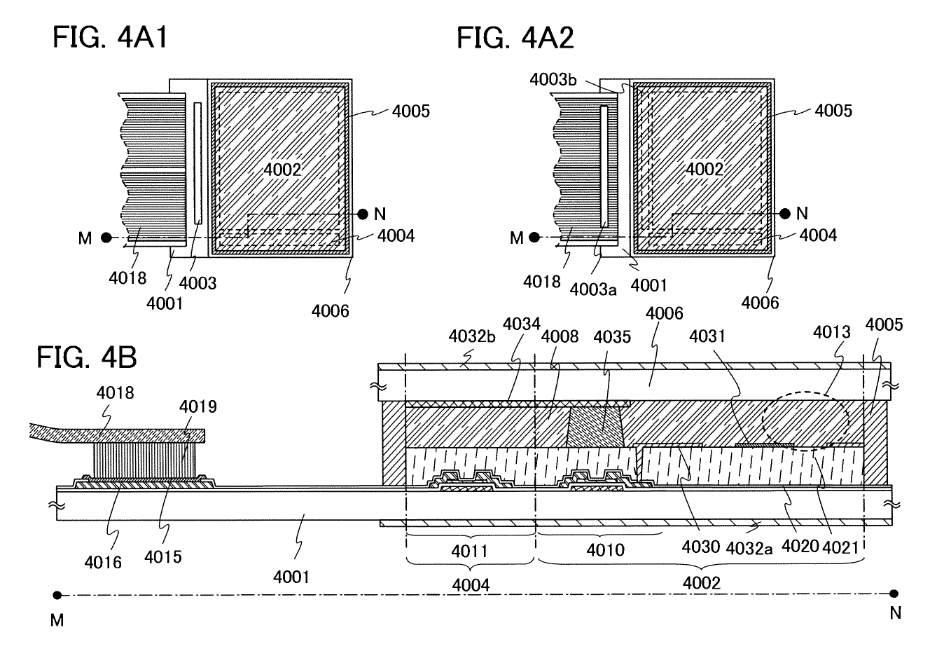

The appearance and a cross section of a liquid crystal display panel, which is one embodiment of a liquid crystal display device, will be described with reference to FIGS. 4A1, 4A2, and 4B. FIGS. 4A1 and 4A2 are each a top view of a panel in which transistors 4010 and 4011 formed over a first substrate 4001 and a liquid crystal element 4013 are sealed between the first substrate 4001 and a second substrate 4006 with a sealant 4005. FIG. 4B is a cross-sectional view taken along line M-N of FIGS. 4A1 and 4A2.

The sealant 4005 is provided to surround a pixel portion 4002 and a scanning line driver circuit 4004 that are provided over the first substrate 4001. The second substrate 4006 is provided over the pixel portion 4002 and the scanning line driver circuit 4004. Thus, the pixel portion 4002 and the scanning line driver circuit 4004 are sealed together with a liquid crystal composition 4008, by the first substrate 4001, the sealant 4005, and the second substrate 4006.

In FIG. 4A1, a signal line driver circuit 4003 that is formed using a single crystal semiconductor film or a polycrystalline semiconductor film over a substrate separately prepared is mounted in a region different from the region surrounded by the sealant 4005 over the first substrate 4001. Note that FIG. 4A2 illustrates an example in which part of the signal line driver circuit is formed using a transistor provided over the first substrate 4001. A signal line driver circuit 4003b is formed over the first substrate 4001, and a signal line driver circuit 4003a formed using a single crystal semiconductor film or a polycrystalline semiconductor film is mounted on a substrate separately prepared.

Note that there is no particular limitation on the connection method of a driver circuit which is separately formed, and a COG method, a wire bonding method, a TAB method, or the like can be used. FIG. 4A1 illustrates an example of mounting the signal line driver circuit 4003 by a COG method, and FIG. 4A2 illustrates an example of mounting the signal line driver circuit 4003a by a TAB method.

The pixel portion 4002 and the scanning line driver circuit 4004 provided over the first substrate 4001 each include a plurality of transistors. FIG. 4B illustrates the transistor 4010 included in the pixel portion 4002 and the transistor 4011 included in the scanning line driver circuit 4004. An insulating layer 4020 and an interlayer film 4021 are provided over the transistors 4010 and 4011.

The transistor which is described in Embodiment 2 can be used as the transistors 4010 and 4011.

Further, a conductive layer may be provided over the interlayer film 4021 or the insulating layer 4020 so as to overlap with a channel formation region of a semiconductor layer of the transistor 4011 for the driver circuit. The conductive layer may have the same potential as or a potential different from that of a gate electrode layer of the transistor 4011 and can function as a second gate electrode layer. Further, the potential of the conductive layer may be GND or the conductive layer may be in a floating state.

A pixel electrode layer 4030 and a common electrode layer 4031 are provided over the interlayer film 4021, and the pixel electrode layer 4030 is electrically connected to the transistor 4010. The liquid crystal element 4013 includes the pixel electrode layer 4030, the common electrode layer 4031, and the liquid crystal composition 4008. Note that a polarizing plate 4032a and a polarizing plate 4032b are provided on the outer sides of the first substrate 4001 and the second substrate 4006, respectively.

In this embodiment, a liquid crystal composition exhibiting a blue phase and including nematic liquid crystal, a chiral agent, a polymerizable monomer, and a photopolymerization initiator which absorbs light with a peak wavelength that is different from a peak wavelength of light absorbed by the nematic liquid crystal is used as a liquid crystal composition 4008. The liquid crystal composition 4008 is provided in a liquid crystal display device with a blue phase exhibited (with a blue phase shown) by polymer stabilization treatment. The liquid crystal composition 4008 further includes an organic resin.

A peak wavelength of light the nematic liquid crystal absorbs is different from a peak wavelength of light the photopolymerization initiator absorbs and the liquid crystal composition is irradiated with light absorbed by the photopolymerization initiator, whereby the polymer stabilization treatment is performed on the liquid crystal composition. With the above manufacturing method, a voltage holding property of the liquid crystal display device can be improved. Further, response speed can be increased. This is because deterioration of the nematic liquid crystal due to light irradiation can be reduced, and the photopolymerization initiator can be activated by the light irradiation, so that polymerization can proceed effectively. Thus, a highly reliable liquid crystal display device can be manufactured.

The structures of the pixel electrode layer and the common electrode layer described in Embodiment 1 or Embodiment 2 can be used for the pixel electrode layer 4030 and the common electrode layer 4031. The pixel electrode layer 4030 and the common electrode layer 4031 have opening patterns.

With an electric field generated between the pixel electrode layer 4030 and the common electrode layer 4031, liquid crystal in the liquid crystal composition 4008 is controlled. An electric field in a lateral direction is formed in the liquid crystal, so that liquid crystal molecules can be controlled using the electric field. Since the liquid crystal molecules aligned to exhibit a blue phase can be controlled in the direction parallel to the substrate, a wide viewing angle is obtained.

As the first substrate 4001 and the second substrate 4006, glass, plastic, or the like having a light-transmitting property can be used. As plastic, a polyvinyl fluoride (PVF) film, a polyester film, or an acrylic resin film can be used. A sheet with a structure in which an aluminum foil is sandwiched between PVF films or polyester films, or a fiberglass-reinforced plastics (FRP) plate can also be used.

A columnar spacer denoted by reference numeral 4035 is obtained by selective etching of an insulating film and is provided to control the thickness of the liquid crystal composition 4008 (a cell gap). Alternatively, a spherical spacer may be used. In the liquid crystal display device including the liquid crystal composition 4008, the cell gap which is the thickness of the liquid crystal composition is preferably greater than or equal to 1 μm and less than or equal to 20 μm. In this specification, the thickness of a cell gap refers to the maximum thickness (film thickness) of a liquid crystal composition.

Although FIGS. 4A1, 4A2, and 4B illustrate examples of transmissive liquid crystal display devices, one embodiment of the present invention can also be applied to a transflective liquid crystal display device and a reflective liquid crystal display device.

FIGS. 4A1, 4A2, and 4B illustrate examples of liquid crystal display devices in which a polarizing plate is provided on the outer side (the viewing side) of a substrate; however, the polarizing plate may be provided on the inner side of the substrate. The position of the polarizing plate may be determined as appropriate depending on the material of the polarizing plate and conditions of the manufacturing process. Furthermore, a light-blocking layer serving as a black matrix may be provided.

A color filter layer or a light-blocking layer may be formed as part of the interlayer film 4021. In FIGS. 4A1, 4A2, and 4B, a light-blocking layer 4034 is provided on the second substrate 4006 side so as to cover the transistors 4010 and 4011. By providing the light-blocking layer 4034, the contrast can be more increased and the transistors can be more stabilized.

The transistors may be, but is not necessarily, covered with the insulating layer 4020 which functions as a protective film of the transistors.

Note that the protective film is provided to prevent entry of contaminant impurities such as an organic substance, metal, and moisture in the air and is preferably a dense film. The protective film may be formed by a sputtering method to have a single-layer structure or a stacked-layer structure including any of a silicon oxide film, a silicon nitride film, a silicon oxynitride film, a silicon nitride oxide film, an aluminum oxide film, an aluminum nitride film, an aluminum oxynitride film, and an aluminum nitride oxide film.

Further, in the case of further forming a light-transmitting insulating layer as a planarizing insulating film, the light-transmitting insulating layer can be formed using an organic material having heat resistance, such as polyimide, acrylic, a benzocyclobutene-based resin, polyamide, or epoxy. As an alternative to such organic materials, it is possible to use a low-dielectric constant material (low-k material), a siloxane-based resin, phosphosilicate glass (PSG), borophosphosilicate glass (BPSG), or the like. The insulating layer may be formed by stacking a plurality of insulating films formed of these materials.

There is no particular limitation on the method for forming the insulating layer having a stacked structure, and the following method can be employed depending on the material: a sputtering method, a spin coating method, a dip coating method, a spray coating method, a droplet discharging method (such as an ink-jet method), a printing method (such as a screen printing method or an offset printing method), a roll coating method, a curtain coating method, a knife coating method, or the like.

The pixel electrode layer 4030 and the common electrode layer 4031 can be formed using a light-transmitting conductive material such as an indium oxide containing tungsten oxide, an indium zinc oxide containing tungsten oxide, an indium oxide containing titanium oxide, an indium tin oxide containing titanium oxide, an indium tin oxide, an indium zinc oxide, an indium tin oxide to which silicon oxide is added, or graphene.

Alternatively, the pixel electrode layer 4030 and the common electrode layer 4031 can be formed using one or more of the following: metals such as tungsten (W), molybdenum (Mo), zirconium (Zr), hafnium (Hf), vanadium (V), niobium (Nb), tantalum (Ta), chromium (Cr), cobalt (Co), nickel (Ni), titanium (Ti), platinum (Pt), aluminum (Al), copper (Cu), and silver (Ag); alloys thereof; and nitrides thereof.

The pixel electrode layer 4030 and the common electrode layer 4031 can be formed using a conductive composition including a conductive high molecule (also referred to as a conductive polymer).

Further, a variety of signals and potentials are supplied to the signal line driver circuit 4003 which is formed separately, the scanning line driver circuit 4004, or the pixel portion 4002 from an FPC 4018.

Further, since the transistor is easily broken by static electricity or the like, a protective circuit for protecting the driver circuits is preferably provided over the same substrate as a gate line or a source line. The protection circuit is preferably formed using a nonlinear element.

In FIGS. 4A1, 4A2, and 4B, a connection terminal electrode 4015 is formed using the same conductive film as the pixel electrode layer 4030, and a terminal electrode 4016 is formed using the same conductive film as source electrode layers and drain electrode layers of the transistors 4010 and 4011.

The connection terminal electrode 4015 is electrically connected to a terminal included in the FPC 4018 through an anisotropic conductive film 4019.

Although FIGS. 4A1, 4A2, and 4B illustrate an example in which the signal line driver circuit 4003 is formed separately and mounted on the first substrate 4001, one embodiment of the present invention is not limited to this structure. The scanning line driver circuit may be separately formed and then mounted, or only part of the signal line driver circuit or part of the scanning line driver circuit may be separately formed and then mounted.

As described above, a voltage holding property of the liquid crystal display device exhibiting a blue phase can be improved and the liquid crystal display device can have high reliability.

This embodiment can be implemented in appropriate combination with any of the structures described in the other embodiments.

### Embodiment 4

A liquid crystal display device disclosed in this specification can be applied to a variety of electronic devices (including game machines). Examples of electronic devices are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game machine, a portable information terminal, an audio reproducing device, a large-sized game machine such as a pachinko machine, and the like.

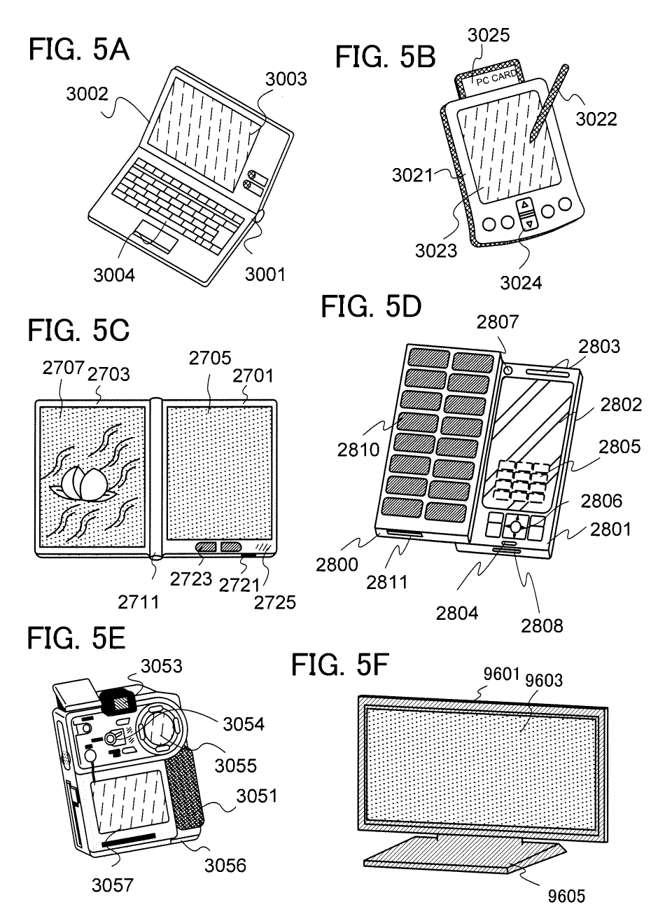

FIG. 5A illustrates a notebook personal computer, which includes a main body 3001, a housing 3002, a display portion 3003, a keyboard 3004, and the like. The liquid crystal display device described in any of Embodiments 1 to 3 is used for the display portion 3003, whereby a highly reliable notebook personal computer with can be provided.

FIG. 5B illustrates a personal digital assistant (PDA), which includes a main body 3021 provided with a display portion 3023, an external interface 3025, operation buttons 3024, and the like. A stylus 3022 is provided as an accessory for operation. The liquid crystal display device described in any of Embodiments 1 to 3 is used for the display portion 3023, whereby a highly reliable personal digital assistant (PDA) can be provided.

FIG. 5C illustrates an e-book reader, which includes two housings, a housing 2701 and a housing 2703. The housing 2701 and the housing 2703 are combined with a hinge 2711 so that the e-book reader can be opened and closed with the hinge 2711 as an axis. With such a structure, the e-book reader can operate like a paper book.

A display portion 2705 and a display portion 2707 are incorporated in the housing 2701 and the housing 2703, respectively. The display portion 2705 and the display portion 2707 may display one image or different images. In the structure where different images are displayed in the above display portions, for example, the right display portion (the display portion 2705 in FIG. 5C) can display text and the left display portion (the display portion 2707 in FIG. 5C) can display a different image. The liquid crystal display device described in any of Embodiments 1 to 3 is used for the display portions 2705 and 2707, whereby a highly reliable e-book reader can be provided. In the case of using a transflective or reflective liquid crystal display device as the display portion 2705, the e-book reader may be used in a comparatively bright environment; therefore, a solar cell may be provided so that power generation by the solar cell and charge by a battery can be performed. When a lithium ion battery is used as the battery, there are advantages of downsizing and the like.

FIG. 5C illustrates an example in which the housing 2701 is provided with an operation portion and the like. For example, the housing 2701 is provided with a power switch 2721, operation keys 2723, a speaker 2725, and the like. With the operation keys 2723, pages can be turned. Note that a keyboard, a pointing device, or the like may also be provided on the surface of the housing, on which the display portion is provided. Furthermore, an external connection terminal (an earphone terminal, a USB terminal, or the like), a recording medium insertion portion, and the like may be provided on the back surface or the side surface of the housing. Further, the e-book reader may have a function of an electronic dictionary.

The e-book reader may transmit and receive data wirelessly. Through wireless communication, desired book data or the like can be purchased and downloaded from an electronic book server.

FIG. 5D illustrates a mobile phone, which includes two housings, a housing 2800 and a housing 2801. The housing 2801 includes a display panel 2802, a speaker 2803, a microphone 2804, a pointing device 2806, a camera lens 2807, an external connection terminal 2808, and the like. In addition, the housing 2800 includes a solar cell 2810 having a function of charge of the mobile phone, an external memory slot 2811, and the like. An antenna is incorporated in the housing 2801. The liquid crystal display device described in any of Embodiments 1 to 3 is used for the display panel 2802, whereby a highly reliable mobile phone can be provided.

Further, the display panel 2802 is provided with a touch panel. A plurality of operation keys 2805 which is displayed as images is illustrated by dashed lines in FIG. 5D. Note that a boosting circuit by which a voltage output from the solar cell 2810 is increased to be sufficiently high for each circuit is also provided.

The display direction of the display panel 2802 is changed as appropriate depending on a usage pattern. Further, the camera lens 2807 is provided on the same surface as the display panel 2802, so that the mobile phone can be used as a video phone. The speaker 2803 and the microphone 2804 can be used for videophone calls, recording and playing sound, and the like as well as voice calls. Furthermore, the housings 2800 and 2801 which are developed as illustrated in FIG. 5D can overlap with each other by sliding; thus, the size of the mobile phone can be decreased, which makes the mobile phone suitable for being carried.

The external connection terminal 2808 can be connected to an AC adapter and various types of cables such as a USB cable, and charging and data communication with a personal computer are possible. Moreover, a large amount of data can be stored by inserting a storage medium into the external memory slot 2811 and can be moved.

Further, in addition to the above functions, an infrared communication function, a television reception function, or the like may be provided.

FIG. 5E illustrates a digital video camera, which includes a main body 3051, a display portion A 3057, an eyepiece portion 3053, an operation switch 3054, a display portion B 3055, a battery 3056, and the like. The liquid crystal display device described in any of Embodiments 1 to 3 is used for the display portion A 3057 and the display portion B 3055, whereby a highly reliable digital video camera can be provided.

FIG. 5F illustrates a television set, which includes a housing 9601, a display portion 9603, and the like. The display portion 9603 can display images. Here, the housing 9601 is supported by a stand 9605. The liquid crystal display device described in any of Embodiments 1 to 3 is used for the display portion 9603, whereby a highly reliable television set can be provided.

The television set can operate with an operation switch of the housing 9601 or a separate remote control device. Further, the remote controller may be provided with a display portion for displaying data output from the remote controller.

Note that the television set is provided with a receiver, a modem, and the like. With the use of the receiver, general television broadcasting can be received. Moreover, when the display device is connected to a communication network with or without wires via the modem, one-way (from a sender to a receiver) or two-way (between a sender and a receiver or between receivers) data communication can be performed.

This embodiment can be implemented in appropriate combination with any of the structures described in the other embodiments.

### Example 1

In this example, a liquid crystal element which can be used for the liquid crystal display device according to one embodiment of the present invention was manufactured and characteristics were evaluated.

Table 1 shows the structure of a liquid crystal composition used for the liquid crystal element.

TABLE 1

| Material | | | Proportion (wt %) | | | |
|---|---|---|---|---|---|---|
| Liquid | Liquid Crystal 1 | PEP-5FCNF | 18 | 95.0 | 92 | 99.7 |
| Crystal | Liquid Crystal 2 | 5CT | 4.4 | | | |
| | Liquid Crystal 3 | PP-O3FCNF | 6.4 | | | |
| | Liquid Crystal 4 | PP-O5FCNF | 4.8 | | | |
| | Liquid Crystal 5 | PP-O8FCNF | 6.4 | | | |
| | Liquid Crystal 6 | CPEP-5FCNF | 30 | | | |
| | Liquid Crystal 7 | PEP-3FCNF | 30 | | | |

| | | | | |
|---|---|---|---|---|
| Chiral Agent | R-DOL-Pn | 5.0 | | |
| Polymerizable Monomer | RM257-O6 | | 4 | |
| | DMeAc | | 4 | |
| Photopolymerization | DMPAP | | | 0.3 |
| Initiator | | | | |

The following materials were used: 4-cyano-3,5-difluorophenyl 4-n-pentylbenzoate (abbreviation: PEP-5FCNF) as liquid crystal 1; 4-cyano-4″-pentyl-p-terphenyl (abbreviation: 5CT) (manufactured by LCC Corporation) as liquid crystal 2; 4-(4-n-propoxyphenyl)-2,6-difluorobenzonitrile (abbreviation: PP—O3FCNF) as liquid crystal 3; 4-(4-n-pentoxyphenyl)-2,6-difluorobenzonitrile (abbreviation: PP—O5FCNF) as liquid crystal 4; 4-(4-n-octoxyphenyl)-2,6-difluorobenzonitrile (abbreviation: PP—O8FCNF) as liquid crystal 5; 4-cyano-3,5-difluorophenyl 4-(trans-4-n-pentylcyclohexyl)benzoate (abbreviation: CPEP-5FCNF) as liquid crystal 6; and 4-cyano-3,5-difluorophenyl 4-n-propylbenzoate (abbreviation: PEP-3FCNF) as liquid crystal 7.

The structural formulae of PEP-5FCNF (abbreviation), 5CT (abbreviation), PP—O3FCNF (abbreviation), PP-O5FCNF (abbreviation), PP—O8FCNF (abbreviation), CPEP-5FCNF (abbreviation), and PEP-3FCNF (abbreviation) used in this example are shown below.

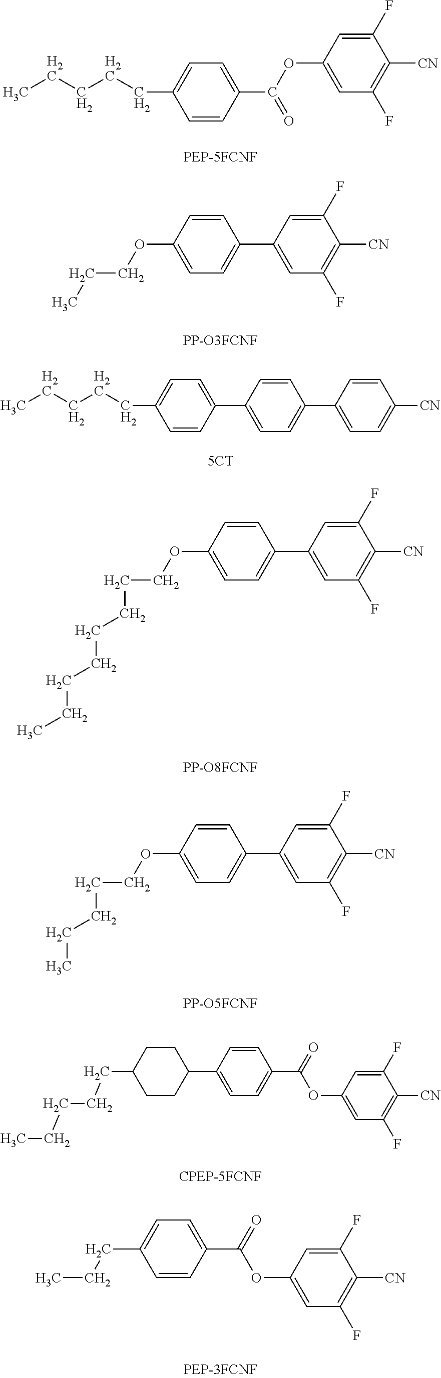

Further, the following materials were used: R-DOL-Pn (abbreviation) as a chiral agent; 1,4-bis-[4-(4-acryloyloxy-n-hexyl-1-oxy)benzoyloxy]-2-methylbenzene (abbreviation: RM257-O6) (manufactured by SYNTHON Chemicals GmbH & Co. KG) and dodecyl methacrylate (abbreviation: DMeAc) (manufactured by Tokyo Chemical Industry Co., Ltd.) as polymerizable monomers; and 2,2-dimethoxy-2-phenylacetophenone (abbreviation: DMPAP) (manufactured by Tokyo Chemical Industry Co., Ltd.) as a photopolymerization initiator.

The structural formulae of R-DOL-Pn (abbreviation), RM257-O6 (abbreviation), DMeAc (abbreviation), and DMPAP (abbreviation) used in this example are shown below.

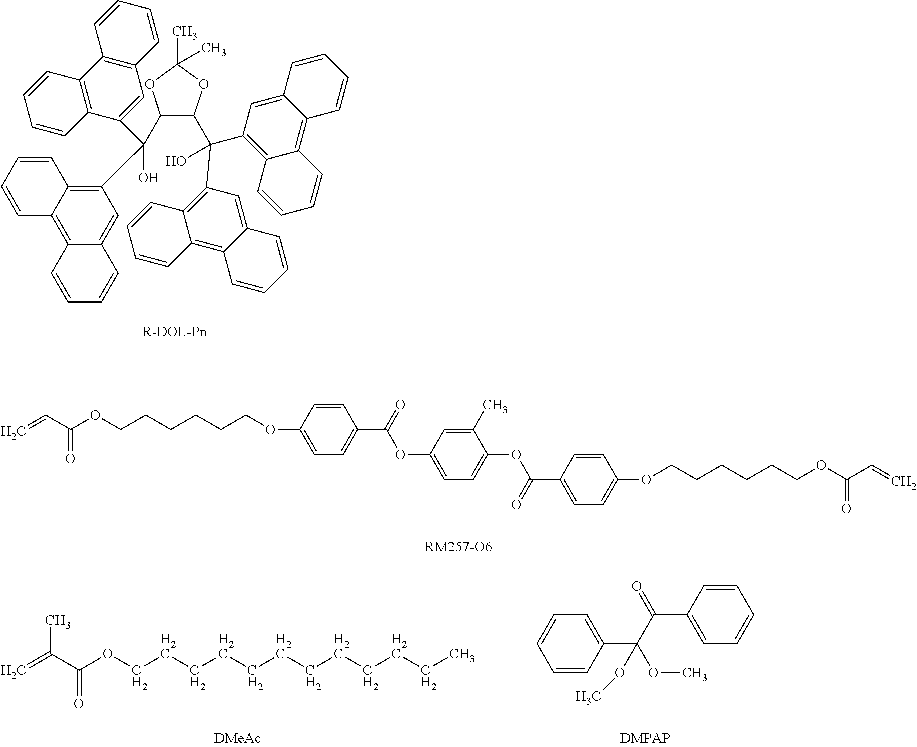

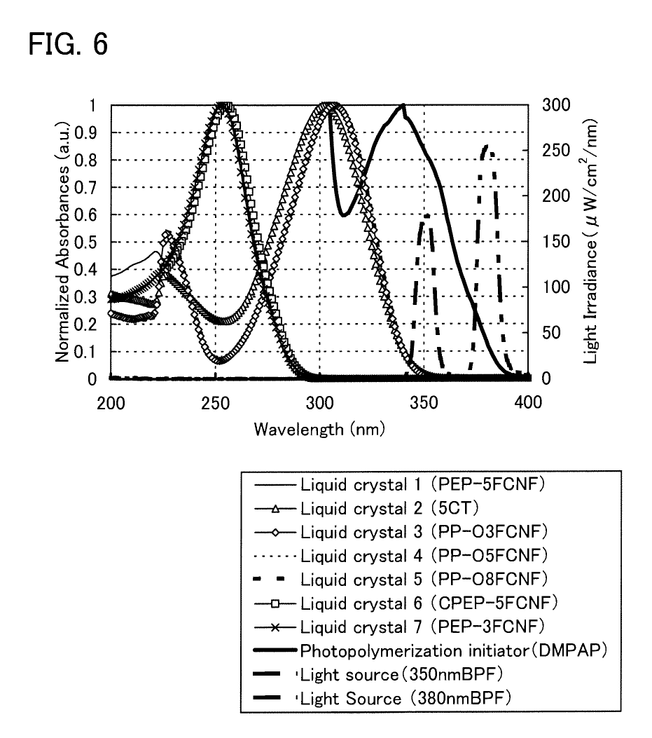

Absorption wavelengths of the liquid crystals 1 to 7 (PEP-5FCNF (abbreviation), 5CT (abbreviation), PP—O3FCNF (abbreviation), PP—O5FCNF (abbreviation), PP—O8FCNF (abbreviation), CPEP-5FCNF (abbreviation), and PEP-3FCNF (abbreviation)) and the photopolymerization initiator (DMPAP (abbreviation)) were measured. The liquid crystals 1 to 7 were each dissolved in a dichloromethane solution to form samples, and the measurements were performed using an ultraviolet-visible spectrophotometer (V-550, manufactured by JASCO Corporation). FIG. 6 shows absorption spectra of the liquid crystals 1 to 7 and the photopolymerization initiator.

Note that in FIG. 6, a fine solid line, a line with triangle data markers, a line with rhombus data markers, a fine dotted line, a thick dotted line, a line with square data markers, a line with cross data markers, and a thick solid line indicate the absorption spectra of the liquid crystal 1 (PEP-5FCNF (abbreviation)), the liquid crystal 2 (5CT (abbreviation)), the liquid crystal 3 (PP—O3FCNF (abbreviation)), the liquid crystal 4 (PP—O5FCNF (abbreviation)), the liquid crystal 5 (PP—O8FCNF (abbreviation)), the liquid crystal 6 (CPEP-5FCNF (abbreviation)), the liquid crystal 7 (PEP-3FCNF (abbreviation)), and the photopolymerization initiator (DMPAP (abbreviation)), respectively.

As shown in FIG. 6, the absorption peak wavelengths of the liquid crystal 1 (PEP-5FCNF (abbreviation)), the liquid crystal 2 (5CT (abbreviation)), the liquid crystal 3 (PP—O3FCNF (abbreviation)), the liquid crystal 4 (PP—O5FCNF (abbreviation)), the liquid crystal 5 (PP—O8FCNF (abbreviation)), the liquid crystal 6 (CPEP-5FCNF (abbreviation)), the liquid crystal 7 (PEP-3FCNF (abbreviation)), and the photopolymerization initiator (DMPAP (abbreviation)) are 253 nm, 302 nm, 307 nm, 307 nm, 307 nm, 255 nm, 253 nm, and 340 nm, respectively.

In this example, a liquid crystal element 1 and a liquid crystal element 2 were manufactured using the liquid crystal composition shown in Table 1. The manufacturing method is described below. The liquid crystal element 1 and the liquid crystal element 2 are different in a wavelength of light used for polymer stabilization treatment.

The liquid crystal element 1 and the liquid crystal element 2 were each manufactured in such a manner that a glass substrate over which a pixel electrode layer and a common electrode layer were formed in comb-like shapes as in FIG. 3D and a glass substrate serving as a counter substrate were bonded to each other using a sealant with a space (4 μm) provided therebetween and then the liquid crystal composition stirred in an isotropic phase was injected between the substrates by an injection method.

The pixel electrode layer and the common electrode layer were formed using an indium tin oxide containing silicon oxide by a sputtering method. The thickness of each of the pixel electrode layer and the common electrode layer was 110 nm, the width thereof was 2 μm, and the distance between the pixel electrode layer and the common electrode layer was 2 μm. Further, an ultraviolet light and heat curable sealant was used as the sealant. As curing treatment, irradiation of ultraviolet light (irradiance of 100 mW/cm²) was performed for 90 seconds, and then, heat treatment was performed at 120° C. for 1 hour.

The polymer stabilization treatment was performed on the liquid crystal element 1 and the liquid crystal element 2 in the following manner: each of the liquid crystal element 1 and the liquid crystal element 2 was set at a given constant temperature within the temperature range from the temperature higher than the maximum temperature where a blue phase is exhibited by 3° C. (the maximum temperature+3° C.) to the minimum temperature where a blue phase is exhibited, and irradiation with light (MAX-302, a xenon lamp light source manufactured by Asahi Spectra Co., Ltd) was performed for 20 minutes. Note that in each of the liquid crystal element 1 and the liquid crystal element 2, the polymerizable monomer contained in the liquid crystal composition are polymerized by the polymer stabilization treatment, so that the liquid crystal element 1 and the liquid crystal element 2 each include a liquid crystal composition containing an organic resin.

As the light used for the polymer stabilization treatment, light emitted from a light source and then passed through a 350-nm band-pass filter (manufactured by Asahi Spectra Co., Ltd) was used for the liquid crystal element 1, and light emitted from a light source and passed through a 380-nm band-pass filter (manufactured by Asahi Spectra Co., Ltd) was used for the liquid crystal element 2. FIG. 6 shows irradiance spectra of the light used for the liquid crystal element 1 (light source (350-nm BPF), indicated by a thick alternate long and short dashed line) and the light used for the liquid crystal element 2 (light source (380-nm BPF), indicated by a thick chain double-dashed line), which were used in the polymer stabilization treatment.

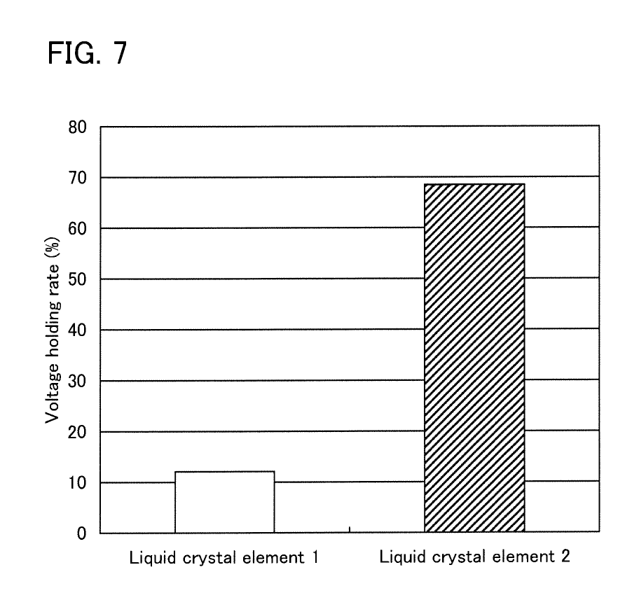

Voltage holding rates of the liquid crystal element 1 and the liquid crystal element 2 were measured using the LC material characteristics measurement system model 6254 (manufactured by TOYO Corporation). A voltage of 30 V was applied to each of the liquid crystal element 1 and the liquid crystal element 2 for 60 μsec at 25° C. so that electric charge was accumulated in each of the liquid crystal element 1 and the liquid crystal element 2 and the voltages after 16.6 msec were measured, so that the voltage holding rates were measured. The voltage holding rates of the liquid crystal element 1 and the liquid crystal element 2 are shown in FIG. 7.

As shown in FIG. 7, the liquid crystal element 1 for which the light passed through a 350-nm band-pass filter was used has a low voltage holding rate of approximately 12%, whereas the liquid crystal element 2 for which the light passed through a 380-nm band-pass filter has a high voltage holding rate higher than or equal to 60%, approximately 70%.

FIG. 6 shows that since an emission spectrum of the light passed through a 380-nm band-pass filter (light source (380-nm BPF)), which was used for the liquid crystal element 2, does not overlap with absorption spectra of the liquid crystals 1 to 7 contained in the liquid crystal composition, light was not absorbed by the liquid crystals 1 to 7 at the time of the light irradiation in the polymer stabilization treatment, so that polymerization of the liquid crystal composition progressed and sufficient polymer stabilization was achieved.

In contrast, since an emission spectrum of the light passed through a 350-nm band-pass filter (light source (350-nm BPF)), which was used for the liquid crystal element 1, partly overlaps with the absorption spectra of the liquid crystals 2 to 5 contained in the liquid crystal composition, light was absorbed by the liquid crystals 2 to 5 at the time of the light irradiation in the polymer stabilization treatment, which may be a cause of insufficient polymerization of the liquid crystal composition and insufficient polymer stabilization.

The above results confirm that a wavelength of light used for the polymer stabilization treatment is preferably a wavelength of light which is absorbed by the photopolymerization initiator but not by the liquid crystal.

Accordingly, a peak wavelength of light a nematic liquid crystal absorbs is different from a peak wavelength of light a photopolymerization initiator absorbs and a liquid crystal composition is irradiated with light absorbed by the photopolymerization initiator, whereby polymer stabilization treatment is performed on the liquid crystal composition, so that a voltage holding property of a liquid crystal display element can be improved. Thus, a highly reliable liquid crystal display device can be manufactured.

### Example 2

Synthesis methods of PEP-5FCNF (abbreviation), PP—O3FCNF (abbreviation), PP—OSFCNF (abbreviation), PP—O8FCNF (abbreviation), CPEP-5FCNF (abbreviation), PEP-3FCNF (abbreviation), and R-DOL-Pn (abbreviation) used in Example 1 are described below.

### Synthetic Method of 4-cyano-3,5-difluorophenyl 4-n-pentylbenzoate (abbreviation: PEP-5FCNF)

A synthetic scheme of PEP-5FCNF (abbreviation) is shown in (M−1) below.

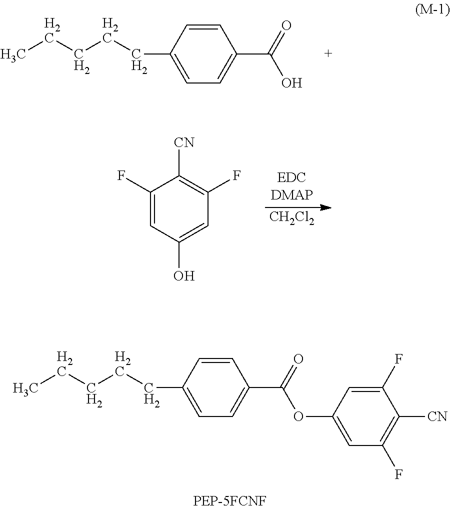

Into a 200-mL recovery flask were put 10 g (52 mmol) of 4-n-pentylbenzoic acid, 8.1 g (52 mmol) of 2,6-difluoro-4-hydroxybenzonitrile, 0.95 g (7.8 mmol) of 4-(N,N-dimethyl)aminopyridine (DMAP), and 52 mL of dichloromethane, and stirring was performed. To this mixture was added 11 g (57 mmol) of 1-ethyl-3-(3-dimethylaminopropyl)carbodiimide hydrochloride (EDC), and stirring was performed overnight in the air at room temperature. After a predetermined time elapsed, water was added to the obtained mixture to extract an aqueous layer with dichloromethane. The obtained extracted solution and an organic layer were combined and washed with a saturated aqueous solution of sodium hydrogen carbonate and saturated saline, and then dried with magnesium sulfate. This mixture was separated by gravity filtration, and the filtrate was condensed to give a solid. This solid was purified by silica gel column chromatography (developing solvent: toluene), whereby an oily colorless substance was obtained. This oily substance was purified by high performance liquid column chromatography (developing solvent: chloroform), whereby 14 g of a white solid was obtained in a yield of 84%.

The 14 g of the obtained white solid was purified by sublimation using a train sublimation method. In the purification by sublimation, the white solid was heated at 140° C. under a pressure of 3.0 Pa with a flow rate of argon gas of 5 mL/min. After the purification by sublimation, 11 g of a white solid was obtained at a collection rate of 79%. This white solid was identified as 4-cyano-3,5-difluorophenyl 4-n-pentylbenzoate (abbreviation: PEP-5FCNF), which was the objective substance, by nuclear magnetic resonance (NMR) spectroscopy.

The ¹H NMR data of the obtained substance is shown below. ¹H NMR (CDCl₃, 300 MHz): 6 (ppm)=0.90 (t, J=6.6 Hz, 3H), 1.27-1.36 (m, 4H), 1.61-1.71 (m, 2H), 2.71 (t, J=7.2 Hz, 2H), 7.05 (dd, J₁=3.0 Hz, J₂=10.8 Hz, 2H), 7.34 (d, J=8.1 Hz, 2H), 8.06 (d, J=6.3 Hz, 2H).

### Synthesis Method of 4-(4-n-propoxyphenyl)-2,6-difluorobenzonitrile (abbreviation: PP—O3FCNF)

A synthetic scheme of PP—O3FCNF is shown in (A-1) below.

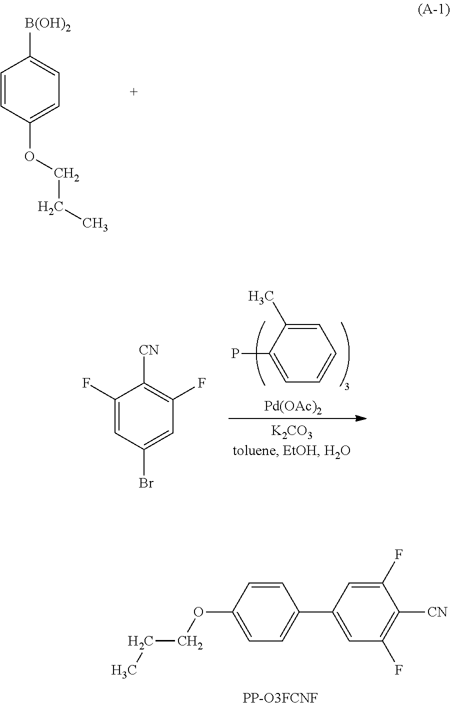

Into a 500-mL three-neck-flask were put 3.0 g (14 mmol) of 4-n-propoxyphenylboronic acid, 3.1 g (14 mmol) of 4-bromo-2,6-difluorobenzonitrile, 0.22 g (0.70 mmol) of tris(2-methylphenyl)phosphine, 30 mg (0.10 mmol) of palladium(II) acetate, and 4.0 g (29 mmol) of potassium carbonate. To the mixture, 54 mL of toluene, 18 mL of ethanol, and 14 mL of pure water were added, and the obtained mixture was degassed by being stirred under reduced pressure. After that, the air in the system was replaced with a nitrogen stream and then the mixture was refluxed at 90° C. for 3 hours.

After that, an aqueous layer of the obtained mixture was subjected to extraction with toluene. The extracted solution and an organic layer were combined and washed with saturated saline, and then dried with magnesium sulfate. This mixture was gravity filtered, and the filtrate was condensed to give a pale yellow solid. The obtained solid was purified by silica gel column chromatography (developing solvent was a mixed solvent of hexane:toluene=2:1), whereby 2.8 g of a white solid was obtained. This solid was purified by high performance liquid column chromatography (developing solvent: chloroform), whereby 2.5 g of white powder was obtained in a yield of 64%.

The 2.5 g of the obtained white powder was purified by sublimation using a train sublimation method. In the purification by sublimation, the white powder was heated at 100° C. under a pressure of 5.5 Pa with a flow rate of argon gas of 15 mL/min. After the purification by sublimation, 1.9 g of white powder was obtained at a collection rate of 76%.

This compound was identified as 4-(4-n-propoxyphenyl)-2,6-difluorobenzonitrile (abbreviation: PP-O3FCNF) by nuclear magnetic resonance (NMR) spectroscopy. The ¹H NMR data of the obtained compound is shown below.

¹H NMR (CDCl₃, 300 MHz): δ=1.06 (t, J=15.0 Hz, 3H), 1.85 (m, J=3.6 Hz, 2H), 3.98 (t, J=13.2 Hz, 2H), 7.00 (d, J=2.4 Hz, 2H), 7.23 (t, J=17.4 Hz, 2H), 7.50 (d, J=2.4 Hz, 2H).

### Synthesis Method of 4-(4-n-pentoxyphenyl)-2,6-difluorobenzonitrile (abbreviation: PP-O5FCNF)

A synthetic scheme of PP—O5FCNF is shown in (B-1) below.

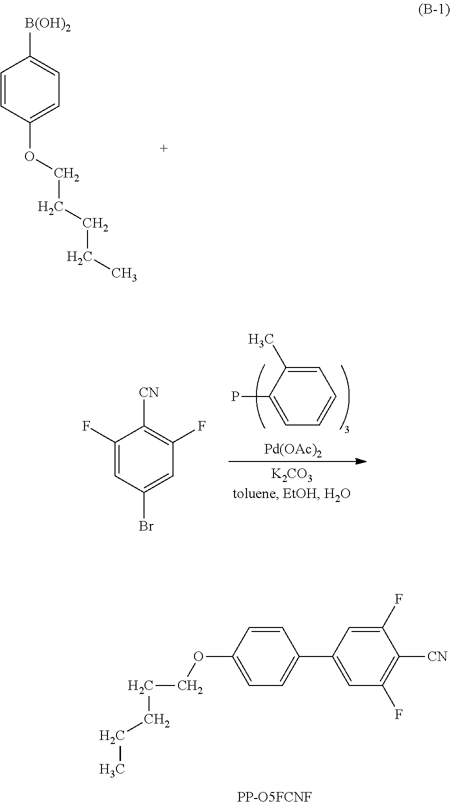

Into a 500-mL three-neck-flask were put 3.0 g (14 mmol) of 4-n-pentoxyphenylboron acid, 3.1 g (14 mmol) of 4-bromo-2,6-difluorobenzonitrile, 0.22 g (0.70 mmol) of tris(2-methylphenyl)phosphine, 30 mg (0.10 mmol) of palladium(II) acetate, and 4.0 g (29 mmol) of potassium carbonate. To this mixture were added 54 mL of toluene, 18 mL of ethanol, and 14 mL of pure water, and the obtained mixture was degassed by being stirred under reduced pressure. After that, the mixture was refluxed at 90° C. for 3 hours.

Then, an aqueous layer of the obtained mixture was subjected to extraction with toluene. The extracted solution and an organic layer were combined and washed with saturated saline, and then dried with magnesium sulfate. This mixture was gravity filtered, and the obtained filtrate was condensed to give a transparent oily substance. The oily substance was purified by silica gel column chromatography (developing solvent was a mixed solvent of hexane:toluene=5:1), whereby 5.0 g of pale yellow liquid was obtained.

The obtained liquid was purified by high performance liquid column chromatography (developing solvent: chloroform), whereby 3.9 g of white powder was obtained.

The 3.9 g of the obtained white powder was purified by sublimation using a train sublimation method. The purification by sublimation was performed by heating the white powder at 95° C. under a pressure of 2.0 Pa with a flow rate of argon gas of 5 mL/min. After the purification by sublimation, 2.0 g of white powder was obtained in a yield of 46%.

This compound was identified as 4-(4-n-pentoxyphenyl)-2,6-difluorobenzonitrile (abbreviation: PP—O5FCNF) by nuclear magnetic resonance (NMR) spectroscopy.

The ¹H NMR data of the obtained compound is shown below. ¹H NMR (CDCl₃, 300 MHz): δ=0.89 (t, J=14.1 Hz, 3H), 1.28-1.49 (m, 4H), 1.77 (m, J=27.6 Hz, 2H), 3.96 (t, J=13.2 Hz, 2H), 6.94 (d, J=2.1 Hz, 2H), 7.18 (t, J=18.0 Hz, 2H), 7.45 (d, J=2.6 Hz, 2H).

### Synthesis Method of 4-(4-n-octoxyphenyl)-2,6-difluorobenzonitrile (abbreviation: PP—O8FCNF)

A synthetic scheme of PP—O8FCNF is shown in (C-1) below.

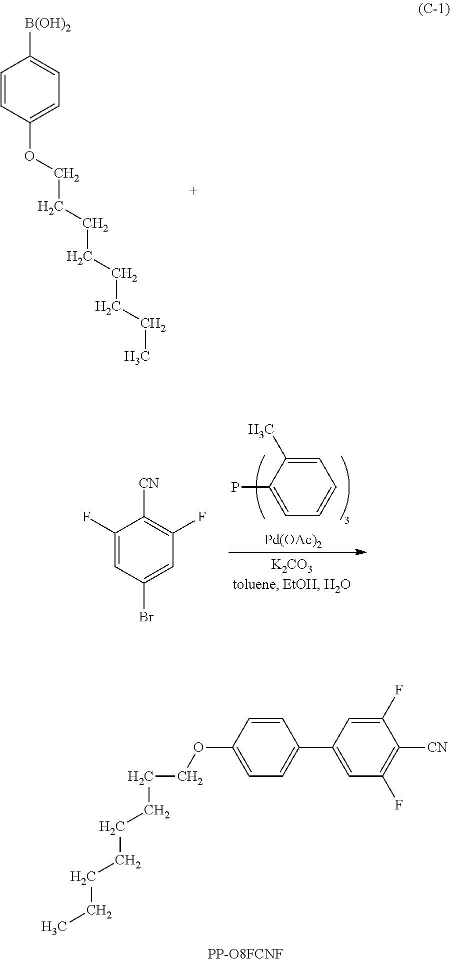

Into a 500-mL three-neck-flask were put 3.0 g (14 mmol) of (4-n-octoxyphenyl)boron acid, 3.1 g (14 mmol) of 4-bromo-2,6-difluorobenzonitrile, 0.22 g (0.70 mmol) of tris(2-methylphenyl)phosphine, 30 mg (0.10 mmol) of palladium(II) acetate, and 4.0 g (29 mmol) of potassium carbonate. To this mixture were added 54 mL of toluene, 18 mL of ethanol, and 14 mL of pure water, and the obtained mixture was degassed by being stirred under reduced pressure. After that, the mixture was refluxed at 90° C. for 3 hours.

Then, an aqueous layer of the mixture was subjected to extraction with toluene. The obtained extracted solution and an organic layer were combined and washed with saturated saline, and then dried with magnesium sulfate. This mixture was gravity filtered, and the filtrate was condensed to give a pale red solid. The obtained solid was purified by silica gel column chromatography (developing solvent was a mixed solvent of hexane:toluene=3:1), whereby 3.5 g of a white solid was obtained. The obtained white solid was purified by high performance liquid column chromatography (developing solvent: chloroform), whereby 2.8 g of white powder was obtained.

The 2.8 g of the obtained white powder was purified by sublimation using a train sublimation method. In the purification by sublimation, the white powder was heated at 110° C. under a pressure of 5.5 Pa with a flow rate of argon gas of 15 mL/min. After the purification by sublimation, 2.2 g of white powder was obtained in a yield of 64%.

This compound was identified as 4-(4-n-octoxyphenyl)-2,6-difluorobenzonitrile (abbreviation: PP—O8FCNF) by nuclear magnetic resonance (NMR) spectroscopy.

The ¹H NMR data of the obtained compound is shown below. ¹H NMR (CDCl₃, 300 MHz): δ=0.89 (t, J=13.5 Hz, 3H), 1.30-1.34 (m, 8H), 1.43-1.53 (m, 2H), 1.81 (m, J=27.9 Hz, 2H), 4.01 (t, J=12.6 Hz, 2H), 7.00 (d, J=2.4 Hz, 2H), 7.23 (t, J=18.0 Hz, 2H), 7.50 (d, J=2.3 Hz, 2H).

### Synthesis Method of 4-cyano-3,5-difluorophenyl 4-(trans-4-n-pentylcyclohexyl)benzoate (abbreviation: CPEP-5FCNF)

A synthetic scheme of CPEP-5FCNF is shown in (F-1) below.

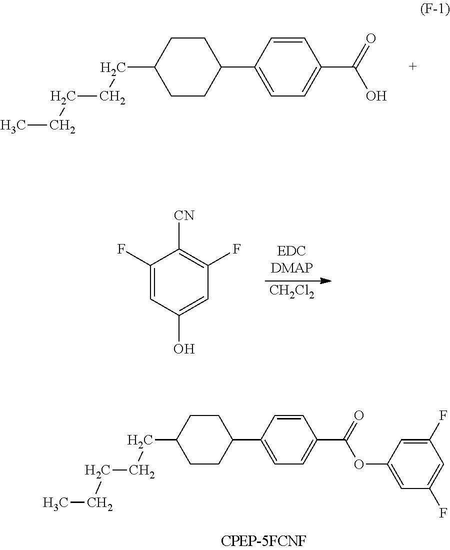

Into a 50-mL recovery flask were put 1.9 g (6.9 mmol) of 4-(trans-4-n-pentylcyclohexyl)benzoic acid, 1.1 g (7.1 mmol) of 2,6-difluoro-4-hydroxybenzonitrile, 0.13 g (1.1 mmol) of 4-(N,N-dimethyl)aminopyridine (DMAP), and 7.0 mL of dichloromethane, and stirring was performed. To this mixture was added 1.5 g (7.8 mmol) of 1-ethyl-3-(3-dimethylaminopropyl)carbodiimide hydrochloride (EDC), and stirring was performed in the air at room temperature for 28 hours. After a predetermined time elapsed, water was added to the obtained mixture to extract an aqueous layer with dichloromethane. The obtained extracted solution and an organic layer were combined and washed with saturated saline, and then dried with magnesium sulfate. This mixture was separated by gravity filtration, and the filtrate was condensed to give a solid. This solid was purified by silica gel column chromatography (developing solvent: toluene). The obtained fraction was condensed to give a solid. This solid was purified by high performance liquid column chromatography (HPLC) (developing solvent: chloroform).

The obtained fraction was condensed, whereby 2.0 g of a white solid, which was the objective substance, was obtained in a yield of 69%. The 2.0 g of the obtained white solid was purified by sublimation using a train sublimation method. In the purification by sublimation, the white solid was heated at 155° C. under a pressure of 2.7 Pa with a flow rate of argon gas of 5 mL/min. After the purification by sublimation, 1.8 g of a white solid was obtained at a collection rate of 90%.

This compound was identified as 4-cyano-3,5-difluorophenyl 4-(trans-4-n-pentylcyclohexyl)benzoate (abbreviation: CPEP-5FCNF), which was the objective substance, by nuclear magnetic resonance (NMR) spectroscopy.

The ¹H NMR data of the obtained substance (CPEP-5FCNF) is shown below. ¹H NMR (CDCl₃, 300 MHz): δ (ppm)=0.90 (t, 3H), 1.02-1.13 (m, 2H), 1.20-1.35 (m, 9H), 1.43-1.54 (m, 2H), 1.89-1.93 (m, 4H), 2.54-2.62 (m, 1H), 7.05 (d, 2H), 7.37 (d, 2H), 8.06 (d, 2H).

### Synthesis Method of 4-cyano-3,5-difluorophenyl 4-n-propylbenzoate (PEP-3FCNF)

A synthetic scheme of PEP-3FCNF is shown in (G-1) below.

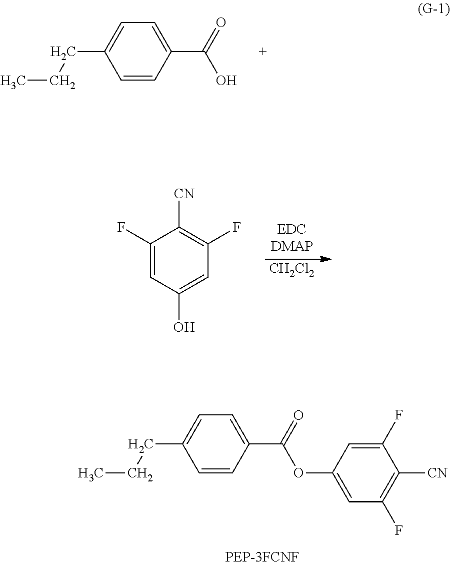

Into a 50-mL recovery flask were put 1.6 g (10 mmol) of 4-n-propylbenzoic acid, 1.6 g (10 mmol) of 2,6-difluoro-4-hydroxybenzonitrile, 0.19 g (1.5 mmol) of 4-(N,N-dimethyl)aminopyridine (DMAP), and 10 mL of dichloromethane, and stirring was performed. To this mixture was added 2.1 g (11 mmol) of 1-ethyl-3-(3-dimethylaminopropyl)carbodiimide hydrochloride (EDC), and stirring was performed in the air at room temperature for 15 hours. After a predetermined time elapsed, water was added to the obtained mixture to extract an aqueous layer with dichloromethane. The obtained extracted solution and an organic layer were combined and washed with a saturated aqueous solution of sodium hydrogen carbonate and saturated saline, and then dried with magnesium sulfate. This mixture was gravity filtered, and the filtrate was condensed to give a white solid. This solid was purified by silica gel column chromatography (developing solvent: toluene). The obtained fraction was condensed to give a white solid. This solid was purified by high performance liquid column chromatography (HPLC) (developing solvent: chloroform). The obtained fraction was condensed, whereby 2.4 g of a white solid, which was the objective substance, was obtained in a yield of 79%.

The 2.4 g of the obtained white solid was purified by sublimation using a train sublimation method. In the purification by sublimation, the white solid was heated at 130° C. under a pressure of 2.1 Pa with a flow rate of argon gas of 10 mL/min. After the purification by sublimation, 1.3 g of a white solid was obtained at a collection rate of 42%.

This compound was identified as 4-cyano-3,5-difluorophenyl 4-n-propylbenzoate (abbreviation: PEP-3FCNF), which was the objective substance, by nuclear magnetic resonance (NMR) spectroscopy.

The ¹H NMR data of the obtained substance (PEP-3FCNF) is shown below. ¹H NMR (CDCl₃, 300 MHz): δ (ppm)=0.97 (t, 3H), 1.63-1.76 (m, 2H), 2.70 (t, 2H), 7.05 (d, 2H), 7.34 (d, 2H), 8.06 (d, 2H).

### Synthesis Method of (R)(R)-4,5-bis[hydroxy (diphenanthryl)methyl]-2,2-dimethyl-1,3-dioxolane (abbreviation: R-DOL-Pn))

A synthetic scheme of R-DOL-Pn (abbreviation) is shown in (L-1) below.

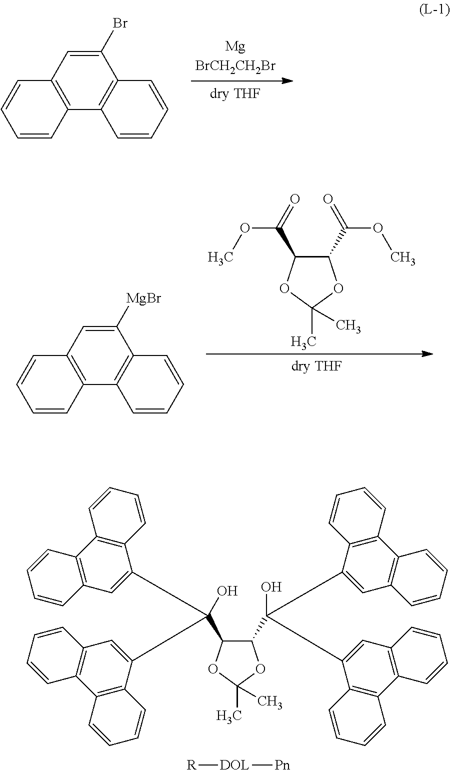

Into a 200-mL three-neck-flask, 2.3 g (95 mmol) of magnesium was put, and the air in the flask was replaced with nitrogen. To this mixture were added 50 mL of dehydrated tetrahydrofuran and 0.5 mL of dibromoethane and the mixture was stirred. To this mixture, a solution in which 25 g (97 mmol) of 9-bromophenanthrene was dissolved in 50 mL of dehydrated tetrahydrofuran was gradually added from a dropping funnel while reflux was maintained. After that, this mixture was refluxed under a nitrogen stream at 80° C. for 2 hours. After a predetermined time elapsed, the mixture was returned to room temperature. To the mixture, a solution in which 3.6 mL (20 mmol) of (R)(R)-2,3-O-isopropylidene-L-dimethylpiperazine was dissolved in 10 mL of dehydrated tetrahydrofuran was gradually added from a dropping funnel while reflux was maintained. Then, the mixture was refluxed under a nitrogen stream at 80° C. for 1 hour. After a predetermined time elapsed, methanol, water, and dilute hydrochloric acid were added in this order into the mixture, and an aqueous layer of the obtained mixture was subjected to extraction with toluene. The obtained extracted solution and an organic layer were combined and washed with a saturated aqueous solution of sodium hydrogen carbonate and saturated saline, and then dried with magnesium sulfate. This mixture was separated by gravity filtration, and the filtrate was condensed to give a yellow oily substance. This oily substance was purified by silica gel column chromatography (developing solvent: toluene). The obtained fraction was condensed to give an oily yellow substance. This oily substance was purified by high performance liquid chromatography (HPLC) (developing solvent: chloroform), whereby a yellow solid was obtained. This solid was recrystallized with toluene, whereby 10 g of a white solid, which was the objective substance, was obtained in a yield of 58%.

### EXPLANATION OF REFERENCE

200: first substrate, 201: second substrate, 204: light, 208: liquid crystal composition, 218: liquid crystal composition, 230: pixel electrode layer, 232: common electrode layer, 401: gate electrode layer, 402: gate insulating layer, 403: semiconductor layer, 405a: wiring layer, 405b: wiring layer, 407: insulating film, 408: common wiring layer, 409: insulating film, 413: interlayer film, 420: transistor, 441: first substrate, 442: second substrate, 443a: polarizing plate, 443b: polarizing plate, 444: liquid crystal composition, 446: second electrode layer, 446a: second electrode layer, 446b: second electrode layer, 446c: second electrode layer, 446d: second electrode layer, 447: first electrode layer, 447a: first electrode layer, 447b: first electrode layer, 447c: first electrode layer, 447d: first electrode layer, 2701: housing, 2703: housing, 2705: display portion, 2707: display portion, 2711: hinge, 2721: power supply, 2723: operation key, 2725: speaker, 2800: housing, 2801: housing, 2802: display panel, 2803: speaker, 2804: microphone, 2805: operation key, 2806: pointing device, 2807: camera lens, 2808: external connection terminal, 2810: solar cell, 2811: external memory slot, 3001: main body, 3002: housing, 3003: display portion, 3004: keyboard, 3021: main body, 3022: stylus, 3023: display portion, 3024: operation button, 3025: external interface, 3051: main body, 3053: eyepiece portion, 3054: operation switch, 3055: display portion, 3056: battery, 3057: display portion, 4001: first substrate, 4002: pixel portion, 4003: signal line driver circuit, 4003a: signal line driver circuit, 4003b: signal line driver circuit, 4004: scanning line driver circuit, 4005: sealant, 4006: second substrate, 4008: liquid crystal composition, 4010: transistor, 4011: transistor, 4013: liquid crystal element, 4015: connection terminal electrode, 4016: terminal electrode, 4018: FPC, 4019: anisotropic conductive film, 4020: insulating layer, 4021: interlayer film, 4030: pixel electrode layer, 4031: common electrode layer, 4032a: polarizing plate, 4032b: polarizing plate, 4034: light-blocking layer, 4035: spacer, 9601: housing, 9603: display portion, and 9605: stand.

This application is based on Japanese Patent Application serial no. 2011-158845 filed with Japan Patent Office on Jul. 20, 2011, the entire contents of which are hereby incorporated by reference.

1. A method for manufacturing a liquid crystal display device, comprising the steps of:
preparing a first substrate and a second substrate between which a liquid crystal composition which is capable of exhibiting a blue phase and includes nematic liquid crystal, a chiral agent, a polymerizable monomer, and a photopolymerization initiator is provided; and
irradiating the liquid crystal composition with light absorbed by the photopolymerization initiator to polymerize the liquid crystal composition,
wherein a first electrode layer and a second electrode layer are provided between the first substrate and the liquid crystal composition, and
wherein a peak wavelength of light absorbed by the nematic liquid crystal is different from a peak wavelength of the light absorbed by the photopolymerization initiator.

2. The method for manufacturing a liquid crystal display device, according to claim 1, wherein the peak wavelength of the light absorbed by the nematic liquid crystal is outside of a wavelength range of the light with which the liquid crystal composition is irradiated.

3. The method for manufacturing a liquid crystal display device, according to claim 1, wherein difference between the peak wavelength of the light absorbed by the nematic liquid crystal and the peak wavelength of the light absorbed by the photopolymerization initiator is 40 nm or more.

4. The method for manufacturing a liquid crystal display device, according to claim 1, wherein the light with which the liquid crystal composition is irradiated has a wavelength greater than or equal to 365 nm and less than or equal to 405 nm.

5. A method for manufacturing a liquid crystal display device, comprising the steps of:
preparing a first substrate and a second substrate between which a liquid crystal composition which is capable of exhibiting a blue phase and includes nematic liquid crystal, a chiral agent, a polymerizable monomer, and a photopolymerization initiator is provided; and
irradiating the liquid crystal composition with light absorbed by the photopolymerization initiator to polymerize the liquid crystal composition,
wherein a first electrode layer and a second electrode layer are provided between the first substrate and the liquid crystal composition,
wherein the nematic liquid crystal includes a plurality of compounds, and
wherein each of peak wavelengths of lights absorbed by the plurality of compounds is different from a peak wavelength of the light absorbed by the photopolymerization initiator.

6. The method for manufacturing a liquid crystal display device, according to claim 5, wherein each of the peak wavelengths of lights absorbed by the plurality of compounds is outside of a wavelength range of the light with which the liquid crystal composition is irradiated.

7. The method for manufacturing a liquid crystal display device, according to claim 5, wherein difference between each of the peak wavelengths of the lights absorbed by the plurality of compounds and the peak wavelength of the light absorbed by the photopolymerization initiator is 40 nm or more.

8. The method for manufacturing a liquid crystal display device, according to claim 5, wherein the light with which the liquid crystal composition is irradiated has a wavelength greater than or equal to 365 nm and less than or equal to 405 nm.

9. A method for manufacturing a liquid crystal display device, comprising the steps of:
preparing a first substrate and a second substrate between which a liquid crystal composition including nematic liquid crystal, a polymerizable monomer, and a photopolymerization initiator is provided; and
irradiating the liquid crystal composition with light absorbed by the photopolymerization initiator to polymerize the liquid crystal composition,
wherein a first electrode layer and a second electrode layer are provided between the first substrate and the liquid crystal composition, and
wherein a peak wavelength of light absorbed by the nematic liquid crystal is different from a peak wavelength of the light absorbed by the photopolymerization initiator.

10. The method for manufacturing a liquid crystal display device, according to claim 9, wherein the nematic liquid crystal includes a plurality of compounds.

11. The method for manufacturing a liquid crystal display device, according to claim 9, wherein the peak wavelength of the light absorbed by the nematic liquid crystal is outside of a wavelength range of the light with which the liquid crystal composition is irradiated.

12. The method for manufacturing a liquid crystal display device, according to claim 9, wherein difference between the peak wavelength of the light absorbed by the nematic liquid crystal and the peak wavelength of the light absorbed by the photopolymerization initiator is 40 nm or more.

13. The method for manufacturing a liquid crystal display device, according to claim 9, wherein the light with which the liquid crystal composition is irradiated has a wavelength greater than or equal to 365 nm and less than or equal to 405 nm.
